(19) United States
(12) Patent Application Publication
(10) Pub. No.: US 2019/0041332 A1
(43) Pub. Date: Feb. 7, 2019

(54) Methods and Systems for Aldehyde Detection

(71) Applicant: Pulse Health LLC, Lake Oswego, OR (US)

(72) Inventors: Gerald Thomas, Springfield, OR (US); Charles Noll, Portland, OR (US); Juven Lara, Portland, OR (US); Brian Young, Portland, OR (US); Craig Carlsen, Lake Oswego, OR (US); Bruce Branchaud, Eugene, OR (US); James Ingle, Corvallis, OR (US)

(21) Appl. No.: 16/050,459

(22) Filed: Jul. 31, 2018

Related U.S. Application Data
(60) Provisional application No. 62/539,872, filed on Aug. 1, 2017.

(51) Int. Cl. G01N 21/64

(52) U.S. Cl. CPC G01N 21/6428; G01N 2021/6439

(57) ABSTRACT

Methods, systems and reagents are provided for detecting and quantifying carbonyl containing moieties in a variety of sample types.

### CROSS-REFERENCE TO RELATED APPLICATION

This application claims the benefit under 35 U.S.C. § 119(e) of U.S. Provisional Patent Application No. 62/539,872, filed Aug. 1, 2017, and titled “Methods and Systems for Aldehyde Detection,” the contents of which are incorporated herein by reference in their entirety.

### TECHNICAL FIELD

The present disclosure is directed to the field of carbonyl detection and quantitation, and in particular, the detection and quantitation of carbonyl containing moieties (CCM) in biological samples.

### BACKGROUND OF THE INVENTION

Oxidative stress is indicative of an imbalance between the production of reactive oxygen species and the ability of the body to detoxify the reactive compounds. Oxidative stress is commonly defined as a pathophysiologic imbalance between oxidative and reductive (anti-oxidative) processes (or oxidants>antioxidants). When the imbalance exceeds cellular repair mechanisms oxidative damage accumulates. Elevated levels of reactive oxidant species are associated with the pathogenesis of a variety of diseases from cardiovascular, pulmonary, autoimmunological, neurological, inflammatory, connective tissues diseases, and cancer. Oxidative stress results in tissue damage and is reportedly involved in diabetes mellitus, hearing loss, vascular disease, neural disease, kidney disease, and much more. Dietary consumption of antioxidants is recommended to combat and prevent a number of diseases and is associated with general health and well-being.

Measuring oxidative stress levels in an individual or patient population can be desirable, but attempts to identify and measure molecules associated with oxidative stress are typically associated with invasive techniques including blood draws, urine samples, and tissue samples. In addition, reactive oxygen molecules associated with oxidative stress are extremely reactive and have short half-lives within and outside the body making direct measurement difficult and inaccurate. At this point a convenient and easy measure of oxidative stress status is not available.

Given the lack of effective methods and devices for identifying individuals or patient populations with oxidative stress, there is a need to advance the industry to better human health.

The present invention is directed toward overcoming one or more of the problems discussed above.

### BRIEF DESCRIPTION OF THE DRAWINGS

FIG. 1 depicts a schematic for a homogeneous single phase reaction for labeling, separating, and detecting aldehydes.

FIG. 2 depicts a Frit stack where a capture column for capturing aldehydes is stacked in a series with a substrate embedded with a catalyst and a substrate embedded with the labeling agent.

FIGS. 3A, B and C depict chromatographs generated using untreated (A) or treated (B) Por-4903 Frit stacks compared to a chromatograph (C) generated using a homogeneous single phase reaction solution shown in FIG. 1.

FIGS. 4A, B and C depict chromatographs generated using untreated (A) or treated (B) X9908 Frit stacks compared to a chromatograph (C) generated using a homogeneous single phase reaction solution shown in FIG. 1.

FIG. 5 depicts an exemplary protocol for preparation of the heterogeneous reactive column.

FIG. 6 depicts a flow diagram of the heterogeneous reaction and aldehyde detection, along with an exemplary chromatograph.

FIG. 7 depicts the difference in reaction rate for standard homogeneous solution method with and without a catalyst. The labeling reaction is slow without a catalyst at low analyte concentrations. In contrast, labeling via the heterogeneous method takes place within the time frame of exposure and elution of about 3-5 minutes. The method is rapid and eliminates the need for a catalyst.

FIGS. 8A, B and C compare a homogeneous single phase reaction solution chromatograph (A) with chromatographs obtained by the heterogeneous labeling method using silica matrix columns (B and C). Gas phase aldehyde samples are prepared using commercially available compressed gas containing certified aldehyde/N₂ mixtures or by direct vaporization from aldehyde solutions.

FIGS. 9A, B and C depict chromatographs obtained using the heterogeneous labeling method with an acid treated silica column (column 150 mg, acid treated silica, XR150 containing labeling agent prepared as described previously; hexanal exposure, 10 L 2 ppb, ≈0.8 nmol aldehyde). Aldehydes are effectively captured and labeled but the subsequent elution is inefficient resulting in labeled aldehydes eluting into several fractions (shown as FIGS. 9A, B and C). This results in dilution of the sample and restricting the analysis and limit of detection.

FIGS. 10A and B depict chromatographs obtained using the heterogeneous labeling method with an acid treated silica column (column 150 mg, acid treated silica, XR150 containing labeling agent prepared as described previously; hexanal exposure, 10 L 2 ppb, ≈0.8 nmol aldehyde). Aldehydes are effectively captured and labeled in this example (A). The elution formulation containing 1% HCl results in efficient elution (removal) of labeled aldehydes eluting into single fraction.

FIG. 11 provides a table with exemplary substrates (solid matrices) tested in the heterogeneous labeling method capture column.

FIG. 12 depicts a flow diagram using a heterogeneous reactive column. The labeling reagent (ao-6-TAMRA) is dispensed directly on to the capture column as solution. Excess reagent is removed by gentle air push. Breath or gas sample is then passed through column. The sample is eluted with MeOH/water solution, and then the aldehydes are separated and quantitated. In this scheme, the reactive labeling reagent is maintained as a solution, the heterogeneous reactive column is formulated in real time at the point of use, and the sample is passed through the column. In some embodiments, the “air push” step is eliminated and the sample is simply passed through the column. The leading edge of the sample then removes the excess solution which is mostly solvent. The reactive agent adheres to the column without drying, avoiding possible solid state stability and contamination issues.

FIG. 13 depicts a chromatograph combining data from the homogeneous solution method with the heterogeneous labeling method. Detection of labeled aldehydes appears to be kinetic driven, mirroring increasing reactivity as a function of aldehyde chain length. Smaller chain aldehydes are disproportionally absent compared to the homogenous solution method of labeling. The heterogeneous solution labeling method is extremely rapid and does not require a catalyst.

FIGS. 14A and B provides kinetic analyses of the homogeneous solution method. The labeling reaction exhibits a kinetic discrimination based on aldehyde chain length with C10 aldehydes reacting much quicker than C3 aldehydes. At high catalyst levels this discrimination is less discernable due to the extent of conversion over the examination interval.

FIG. 15 depicts a comparison of the standard solution method compared to a heterogeneous labeling method using acidic alumina. Solid ao-6-TAMRA was dissolved in MeCN (1 mg/mL), combined in a vial with alumina, and shaken until the dye was evenly distributed on the solid material. Columns were packed using 300 mg of the solid. Columns were exposed to C6 system at 2 ppb for 10 L. Columns were eluted with 40% MeOH, and analyzed by HPLC. A set of Cusil 300s were also run in the standard manner (7 μM ao-6-TAMRA, 3 mM catalyst, 37 mM Citrate pH 4.16, incubation 15 min. interval, quench with IM Sodium bicarbonate pH10). The heterogeneous labeling reaction on alumina was active but not optimized, only 10% conversion relative to the homogenous labeling reaction.

FIG. 16 depicts a vaporization apparatus. Long chain aldehydes such are C7-C10 are not available commercially in the gas phase and must be generated by direct vaporization in-situ (at the time of use). In the direct vaporization method solution prepared aldehyde mixtures are volatized by heat within a three neck round bottom flask. One neck equipped with automated switchable directional value provides inlet flow for carrier gas (N₂). Flow is controlled by mass flow controller, typical flow 2.0 to 3.0 L/min. Aldehyde mixtures contained within a volatile solvent (methanol, acetonitrile) are injected into the apparatus via a syringe attached to the 2^{nd} neck. Typically 30 μL of solution is added. Assuming 100% vaporization, 30 μL of 13.33 μL provides 400 μmol of aldehyde. The system is immersed in a 1 L beaker of water heated to (90-100° C.). A 10 L bag or capture column is attached to the third next or exit port. Following addition of the aldehyde mixture and immersion into the water path, the flow is switched to the “On” position and the C2-C10 vapor is transferred to the 10 L bag or capture column.

### SUMMARY OF THE INVENTION

Provided herein are methods for detecting the presence of at least one carbonyl containing moiety in a sample. In some embodiments, the methods comprise the steps of: (a) dispensing labeling reagent solution onto a capture column, (b) pushing the sample through the column, (c) eluting labeled sample with methanol/water/HCl solution, (d) dispensing labeled sample onto a separation column, (e) separating the labeled aldehydes using isocratic methods or changing gradients of methanol (or other water miscible solvent) and water and/or buffer, and (f) detecting the labeled carbonyl containing moiety. In some embodiments, the time elapsed from (b) through (f) is less than about 1 hour. In some embodiments, the time elapsed from (b) through (c) less than about 10 minutes.

The sample can be selected from a gas or liquid sample, such as an environmental sample, breath sample, a urine sample, a blood sample, a plasma sample, and a sample of the headspace in a culture.

Provided herein are methods of detecting carbonyl containing moieties (CCM) in a gas sample. In some embodiments, the methods comprise: (a) dispensing labeling reagent solution onto a capture column, (b) pushing the sample through the column, (c) eluting labeled CCM with methanol/water/HCl solution, (d) dispensing labeled sample onto a separation column, (e) eluting the CCM from the separation column, (f) exciting the labeled CCM exiting the column, and (g) detecting the CCM by measuring the fluorescence emitted from or absorbed by the labeled CCM. The step of detecting resolves the CCM based on the carbon chain length of the individual CCM.

In some embodiments, the time elapsed from (b) through (g) is less than about 1 hour. In some embodiments, the time elapsed from (b) through (c) less than about 10 minutes.

Provided herein are systems for detecting the presence of at least one carbonyl containing moiety in a sample. In some embodiments, the systems comprise: (i) a sample capture container, and (ii) a device comprising a capture column, wherein a labeling reagent is embedded on the capture column, a separation column, elution solutions, a pump, a light for inducing fluorescence, a detection chamber, and a detector for measuring fluorescence emission, excitation, or absorbance of at least one labeled carbonyl containing moiety.

In some embodiments, the device receives a sample containing at least one carbonyl containing moiety from the sample capture container, deposits the sample onto the capture column embedded with the labeling reagent, performs an elution process on the column to elute the labeled carbonyl containing moiety, dispenses the labeled carbonyl containing moiety onto a separation column, elutes the labeled carbonyl containing moiety from the capture column, measures the labeled carbonyl containing moiety, and presents data identifying and/or quantifying the at least once carbonyl containing moiety.

In addition, provided herein are methods for detecting the presence of at least one aldehyde in a sample. In some embodiments, the methods comprise the steps of: (a) dispensing reactive labeling reagent in solution on to a capture column; (b) pushing the sample through the column; (c) eluting labeled sample with an organic solvent solution, e.g. methanol/water/HCl solution; (d) dispensing labeled sample onto a separation column; (e) separating the labeled aldehydes using isocratic methods or changing gradients of methanol (or other water miscible solvent) and water and/or buffer; and (f) detecting labeled aldehydes in the solution. In some embodiments, the time elapsed from (b) through (f) is less than about 1 hour. In some embodiments, the time elapsed from (b) through (c) less than about 10 minutes.

### DESCRIPTION

The description, experiments, and drawings provided herein are illustrative and are not to be construed as limiting. Numerous specific details are described to provide a thorough understanding of the disclosure. However, in certain instances, well-known or conventional details are not described in order to avoid obscuring the description. References to one or another embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. Appearances of the phrase “in one embodiment” in various places in the specification do not necessarily refer to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of methods, systems, reagents, and compounds according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Provided herein are heterogeneous solid phase methods and systems for the detection of low level CCM, e.g., aldehydes, ketones, carboxylic acids, in gas samples (for example, breath) or solution samples.

The phrase “heterogeneous reaction” can be considered a general class of reaction involving components in two or more phases (gas-liquid, gas-solid, liquid-solid, solid-solid) and/or two or more non-immiscible liquids (e.g. oil-water). The term here is extended beyond the traditional chemical definition to include reactions involving heterogeneous mixtures (i.e. non-uniform in composition, appearance or form) or systems in which one or more of the reactants are stored on or dispensed from different phases, i.e. delivered as a solid on a solid support. In contrast, a homogenous reaction occurs in a single phase with a homogenous mixture, uniform composition, and uniform appearance of reactants. In this context, a homogenous reaction is used to describe the solution phase labeling reaction in which all components or reactants are dispensed as liquid reagents. In addition, the phrase “heterogeneous catalyst” generally refers to gas, liquid, or solid phase reactions utilizing a solid phase catalyst.

Heterogeneous reactions involving one or more phases provide several potential advantages over conventional homogeneous single phase reactions including: 1) enhanced reaction rates and conversion efficiency, 2) greater chemical selectivity, 3) cleaner products, and 4) manipulative simplicity. Heterogeneous reactions facilitated by supported reagents on various solid surfaces have received considerable attention and form the basis of important generalized synthetic methodologies for the preparation of nucleic acids, proteins and other important chemicals (George, Introduction: Heterogeneous Catalysis, Chemical Reviews, 1995, Vol. 95(3): 475-476; Ballini et al., Amberlyst A-21, an Excellent Heterogeneous Catalyst for the Conversion of Carbonyl Compounds to Oximes, Chemistry Letters, 1997, 26(5):475-476; Hajipour et al., A Convenient and Mild Procedure for the Synthesis of Hydrazones and Semicarbazones from Aldehydes or Ketones under Solvent-free Conditions, J. Chem. Research, Synopses, 1999, 9:570-571; Hattori, Heterogeneous Basic Catalysis, Chem. Rev., 1995, 95(3): 537-550; Schwarz et al., Methods for Preparation of Catalytic Materials, Chem. Rev., 1995, 95(3): 477-510).

These systems leverage a number of different factors, the “activity” of the surface, the localized high concentration of reactants and the ability to orientate reactants. Depending upon the “activity” of the surface, the solid support can be an active participant in the reaction providing direct chemical catalysis or can be an assisting by-stander to the process, directing and facilitating the proximity and orientation of the reactants. In many cases, both mechanisms are operational yielding increased rates and greater product fidelity due to a reduction in side reactions or pathways over that observed for homogeneous processes within a bulk media or solution. Also, depending upon the physical and chemical nature, the solid support can facilitate the reaction and subsequent analyte detection by providing increased capture of trace volatile gas phase and solution analytes. In this manner a solid phase heterogeneous reaction system provides increased overall capture efficiency by “locking” the analyte or target and preventing de-adsorption from the surface.

Use of a heterogeneous method includes the following aspects: 1) the surface matrix, reagents and target analytes are chemically and physically compatible, 2) the reaction products are easily removed from the surface, 3) the surface and reagent interface is easily prepared and stable, 4) the surface possesses suitable activity to enhance and support the desired reaction, 5) absorption and de-absorption rates are sufficiently paired, and 6) the surface and system effectively captures the target or analyte of interest. Successful development and application hinges on selection and modulation of the detection reporter molecule and matrix surface properties to ensure a proper match of the analyte, detection or reporter molecule, reactive chemistry and surface matrix properties.

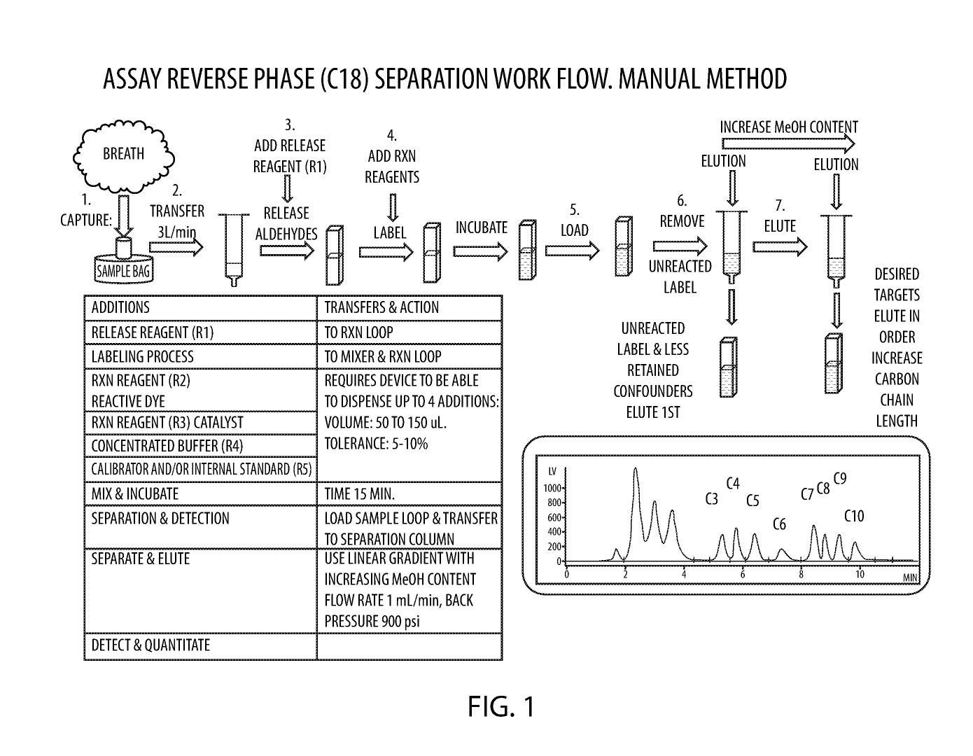

Previous methodology involves the addition of several reagents in solution. The addition volumes are typically required to be small relative to the elution solution (1/10 to 1/20 of the solution, in the 50 μL range) which places additional requirements on the dispensing apparatus used in the system. In addition the method requires a specific order of addition to prevent premature reaction initiation and depletion of the labeling reagent leading to reduced yields and loss of sensitivity. As a result, the automated sample preparation process developed for elution of the targets from a sample such as a breath cartridge, dispensing of reagents, mixing of reagents, incubation, and transfer to the separation load loop can be complex and lengthy. For example, FIG. 1 shows a breath sample 100 captured in a sample bag 102 and transferred to a capture column 104 at approximately 3 liters/minute. Releasing reagents 106 are added to the column and aldehydes, for example, released 108. Reaction reagents 110 are then added to the released aldehydes to provide labeled aldehydes 112. These labeled aldehydes are loaded on a separation column 114 where unreacted reagents are eluted 116 and then target labeled aldehydes are eluted 118. Table 1 shows Additions and Transfer Actions for such a homogenous reaction as shown in FIG. 1, again illustrating the complexity and timing of a homogenous reaction.

TABLE 1
Illustrative Homogenous Reaction

| Addition Steps | Transfers and Actions |
|---|---|
| Release Reagent | Reaction Loop |
| Labeling Process | To Mixer and Reaction Loop |
| Reaction Reagent and | Requires Device to be Able to Dispense |
| Reactive Dye | up to Four Additions Volume 50 to |
| Concentrated Buffer | 150 μl, Tolerance 5-10% |
| Calibrator and/or Internal | |
| Standard | |
| Mix and Incubate | Time 15 Minutes |
| Separation and Detection | Load Sample Loop and Transfer |
| | to Separation Column |
| Separation and Elution | Use Linear Gradient with |
| | Increasing MeOH Content, Flow Rate |
| | 1 mL/Min, Back Pressure , 900 psi |
| Detect and Quantitate | |

In contrast, the heterogeneous solid phase methodology described herein alleviates or mediates the complexities and deficiencies described above and permits efficient detection and quantitation of low levels of target molecules (such as aldehydes) in solution and in the gas phase.

Provided herein are methods and systems useful for the detection, quantitation and assay of carbonyl containing moieties (“CCM”) including aldehydes, ketones, and carboxylic acids. A CCM is a compound having at least one carbonyl group. A carbonyl group is the divalent group >C=0, which occurs in a wide range of chemical compounds. The group consists of a carbon atom double bonded to an oxygen atom. The carbonyl functionality is seen most frequently in three major classes of organic compounds: aldehydes, ketones, and carboxylic acids. It is contemplated herein that the disclosed methods and systems are useful in resolving, detecting, and quantitating mixtures of CCMs.

In one aspect, the CCMs are aldehydes. As such, the methods and systems provided herein are useful in detecting the presence and/or concentration of aldehydes in a variety of samples. Exemplary aldehydes include C1 aldehydes, C2 aldehydes, C3 aldehydes, C4 aldehydes, C5 aldehydes, C6 aldehydes, C7 aldehydes, C8 aldehydes, C9 aldehydes, C10 aldehydes, C11 aldehydes, C12 aldehydes, and C13 aldehydes. Exemplary aldehydes include aliphatic aldehydes, di-aldehydes, and aromatic aldehydes. It is contemplated herein that the disclosed methods and systems are useful in resolving, detecting, and quantitating mixtures of aldehydes. Exemplary aldehydes include without limitation: 1-hexanal, malondialdehyde, 4-hydroxynonenal, acetaldehyde, 1-propanal, 2-methylpropanal, 2,2-dimethylpropanal, 1-butanal, and 1-pentanal. In some embodiments, the sample comprises two or more aldehydes of different carbon chain lengths, and the step of eluting the labeled aldehyde resolves each aldehyde based on carbon chain length.

Further, as used herein, the term “an aldehyde” is intended to refer to any compound that may be chemically characterized as containing one or more aldehyde functional groups. In some embodiments, a pass/fail type indication will be made indicating that some minimum concentration of a specific aldehyde or group of aldehydes is present. In some embodiments, an estimation of the concentration is made. Various embodiments are designed to be specific for specific aldehyde(s), for groups of aldehydes of interest, or for all aldehydes in a sample.

In another aspect, the CCMs are ketones. As such, the methods and systems provided herein are useful in detecting the presence and/or concentration of ketones in a variety of samples. Ketones can have a carbon length of from C3 to C13, for example, and include compounds like 2-propanone, 2-butanone, 2-pentanone, 2-hexanone, 3-pentanone, 3-hexanone, 3-heptanone, etc. As used herein, the term “an ketone” is intended to refer to any compound that may be chemically characterized as including a carbon atom attached to both an oxygen atom (double covalent bond), and also two other carbon atoms (single covalent bonds in each case).

In still another aspect, the CCMs are carboxylic acids. As such, the methods and systems herein are useful in detecting the presence and/or concentration of carboxylic acids in a variety of samples. Carboxylic acids have a carbon length of from C1 to C13, for example, and include compounds like carbonic acid, methanoic acid, ethanoic acid, propanoic acid, butanoic acid, pentanoic acid, and the like. As used herein, the term “carboxylic acid” is intended to refer to any compound that may be chemically characterized as including a carboxyl group, a carbon atom attached to both an oxygen atom (double covalent bond), and a hydroxyl group (single covalent bond).

The methods and systems provided herein have a wide range of utility in a variety of applications in which indication of the presence and/or estimation of concentration of a CCM, such as an aldehyde, a ketone, or a carboxylic acid, is useful.

Embodiments include applications useful in food and agricultural related testing. The oxidation of oils, for example, has important effects on the quality of oily foods. Such oxidation generates CCMs, such as aldehydes, including the unsaturated aldehydes 2-heptenal, 2-octenal, 2-decenal, 2-undecenal and 2,4-decadienal, and/or trans molecules of these compounds. Similarly, levels of formaldehyde and acetaldehyde in fish and seafood can indicate poor quality. Lipids present in foods react with oxygen and other substances to produce aldehydes, and the level of lipid oxidation (and hence the concentration of aldehydes) can be indicative of poor food quality. Other applications include environmental and others in which aldehyde presence in gasses or liquids can be indicative of gas or liquid quality or pollution thereof.

Embodiments provided herein also include methods and systems for detecting and quantitating CCM, including aldehydes, ketones, and carboxylic acids associated with oxidative stress. Illustratively, the detection and quantitation of alkyl aldehydes, by-products of lipid peroxidation associated with oxidative stress, and oxidative biological processes, can inform a care-giver or practitioner regarding the oxidative stress status of a subject. The subject can be an animal involved with food production (dairy cow), an animal such as a horse, or a domesticated pet, or can be a human in need of health related feedback.

As such, embodiments also include detection or quantitation of aldehydes, ketones or carboxylic acids in order to provide information on the general health and wellness of a subject, for example, a patient. In some embodiments, the information can be indicative of a patient's level of oxidative stress. In some embodiments, aldehydes may be measured or analyzed to assist in the medical diagnosis of a patient. For example, aldehydes in breath (or urine, blood, plasma, or headspace of cultured biopsied cells) may be sampled to determine a patient's overall health and/or whether the patient suffers from certain medical conditions. Aldehyde and ketone sampling may indicate whether a patient has cancer, for example, esophageal and/or gastric adenocarcinoma, lung cancer, colorectal cancer, liver cancer, head cancer, neck cancer, bladder cancer, or pancreatic cancer, may indicate whether a patient suffers from a pulmonary disease (including asthma, acute respiratory distress syndrome, tuberculosis, COPD/emphysema, cystic fibrosis, and the like), neurodegenerative diseases, cardiovascular diseases, or is at risk of an acute cardiovascular event, infectious diseases (including mycobacterium tuberculosis, pseudomonas aeruginosa, aspergillus fumigatus, and so on), gastrointestinal infections (including Campylobacter jejuni, Clostridium difficile, H. pylori, and the like), urinary tract infections, sinusitis, and other conditions. Aldehyde sampling may also indicate the severity or staging of a particular disease or condition, or the effectiveness of a particular treatment.

Illustratively, methods and systems provided herein can specifically measure the presence and/or concentration of malondialdehyde, an unsaturated molecule with two aldehyde functional groups, from biologic samples (breath, urine, blood, saliva, others) or environmental samples (water, air, etc.). Detection of aldehydes in a biologic sample can be useful for indicating oxidative stress in living beings. In some embodiments, methods, reagents, compounds, and systems provided herein are useful to measure other various compounds containing one or more aldehyde groups, including saturated and/or unsaturated molecules, as biomarkers for various diseases and conditions. The aldehyde concentration in human breath can serve as a biomarker useful to screen for the presence of lung cancer, for example.

In accordance with one embodiment, there are provided herein methods for detecting the presence of at least one carbonyl containing moiety in a sample. In some aspects, the methods comprise the steps of: (a) dispensing labeling reagent solution onto a capture column, (b) pushing the sample through the column, (c) eluting labeled sample with methanol/water/HCl solution, (d) dispensing labeled sample onto a separation column, (e) eluting the at least one carbonyl containing moiety from the separation column, and (f) detecting the labeled carbonyl containing moiety. In some embodiments, the time elapsed from (b) through (f) is less than about 1 hour, e.g. less than about 50 minutes, less than about 40 minutes, less than about 30 minutes, or less than about 20 minutes. In some embodiments, the time elapsed from (b) through (c) less than about 10 minutes or less than about 5 minutes.

The sample can be selected from a gas or liquid sample, such as an environmental sample, breath sample, a urine sample, a blood sample, a plasma sample, and a sample of the headspace in a culture.

In accordance with one embodiment, there are provided herein methods of detecting CCM in a gas sample. In some aspects, the methods comprise: (a) dispensing labeling reagent solution onto a capture column, (b) pushing the sample through the column, (c) eluting labeled CCM with methanol/water/HCl solution, (d) dispensing labeled sample onto a separation column, (e) eluting the CCM from the separation column, (f) exciting the labeled CCM exiting the column, and (g) detecting the CCM by measuring the fluorescence emitted from or absorbed by the labeled CCM. The step of detecting resolves the CCM based on the carbon chain length of the individual CCM. In some embodiments, the time elapsed from (b) through (g) is less than about 1 hour, e.g. less than about 50 minutes, less than about 40 minutes, less than about 30 minutes, or less than about 20 minutes. In some embodiments, the time elapsed from (b) through (c) less than about 10 minutes, or less than about 5 minutes.

In accordance with one embodiment, there are provided herein methods for detecting the presence of at least one aldehyde in a sample. In some aspects, the methods comprise the steps of: (a) dispensing reactive labeling reagent in solution on to a capture column; (b) pushing the sample through the column; (c) eluting labeled sample with methanol/water/HCl solution; (d) dispensing labeled sample onto a separation column; (e) separating the labeled aldehydes using changing gradients of methanol and water; and (f) detecting labeled aldehydes in the solution. In some embodiments, the time elapsed from (b) through (f) is less than about 1 hour, e.g. less than about 50 minutes, less than about 40 minutes, less than about 30 minutes, or less than about 20 minutes. In some embodiments, the time elapsed from (b) through (c) is less than about 10 minutes, or less than about 5 minutes.

### Sample Sources

As used herein, a “biological sample” is referred to in its broadest sense, and includes a gas or a liquid or any biological sample obtained from nature, including an individual, environmental, body fluid, cell line, tissue culture, or any other source. As indicated, biological samples include body fluids or gases, such as breath, blood, semen, lymph, sera, plasma, urine, synovial fluid, spinal fluid, sputum, pus, sweat, as well as gas or liquid samples from the environment such as plant extracts, pond water and so on. The biological sample for one embodiment provided herein is the breath of a human. The biological sample for one embodiment provided herein is the headspace obtained from culture of a tissue sample.

Though the methods, reagents, compounds, and systems provided herein can apply to a variety of sample types, in the medical use context, breath analysis represents a promising non-invasive alternative to serum chemistry. A compendium of volatile organic compounds (VOCs) with relatively low molecular weight reflects distinct and immediate changes as a result of alterations in pathophysiological processing and metabolism. Changes in the appearance and population of VOCs in breath reflect changes in metabolism and disease states. Provided herein are methods and systems for detection and differentiation of diseases from exhaled breath.

It will be appreciated that any biological sample can be analyzed using the system. Breath constituents other than CCM or aldehydes can be captured and analyzed as desired. U.S. Patent Publication Nos. 2003/0208133 and 2011/0003395 are incorporated by reference herein in their entireties.

### Illustrative Methods and Systems

Provided herein is a non-invasive system for the quantification of oxidative stress status. Oxidative stress is commonly defined as a pathophysiologic imbalance between oxidative and reductive (anti-oxidative) processes (or oxidants>antioxidants). When the imbalance exceeds cellular repair mechanisms, oxidative damage accumulates. Elevated levels of reactive oxidant species are associated with the pathogenesis of a variety of diseases from cardiovascular, pulmonary, autoimmunological, neurological, inflammatory, connective tissues diseases and cancer. However, by-products of lipid oxidation in breath and other biological samples are present in such low quantities exceeding the limit of detection of conventional devices and methods. Furthermore, these same by-products are not stable in a sample over time, and attempts to identify or quantitate such molecules are unsuccessful due to degradation prior to or during analysis. The method provides for rapid detection and quantitation of trace levels of alkyl aldehydes. Sub-picomoles of aldehydes can be quantitated following 15 minutes of incubation and separation, with a total time approximately 35 minutes. Employing a reactive and nonreactive internal standard pair for correction of reaction efficiency an LOD of less than 0.13 pico mole can be observed, for example, an LOD of less than 0.08 pmol, or less than 0.07 pmol, or less than 0.06 pmol, or less than 0.05 pmol. Optically, labeled aldehydes can be detected down to 1 to 10 femto moles depending upon the sensitivity of the detector.

In accordance with one embodiment, there are provided herein systems for detecting the presence of at least one carbonyl containing moiety in a sample. In some aspects, the systems comprise: (i) a sample capture container, and (ii) a device comprising a capture column, wherein a labeling reagent is embedded on the capture column, a separation column, elution solutions, a pump, a light for inducing fluorescence, a detection chamber, and a detector for measuring fluorescence emission, excitation, or absorbance of at least one labeled carbonyl containing moiety. In some aspects, the device further comprises one or more standards for measuring the concentration of the at least one carbonyl containing moiety.

Illustratively, the device can receive a sample containing at least one carbonyl containing moiety from the sample capture container, deposits the sample onto the capture column embedded with the labeling reagent, performs an elution process on the column to elute the labeled carbonyl containing moiety, dispenses the labeled carbonyl containing moiety onto a separation column, elutes the labeled carbonyl containing moiety from the capture column, measures the labeled carbonyl containing moiety, and presents data identifying the at least once carbonyl containing moiety.

Provided herein are methods and systems for measuring oxidative stress. In some embodiments, the methods and systems detect and/or quantitate by-products of lipid oxidation, for example, alkyl aldehydes and ketones. In some embodiments, these by-products are measured in a sample of exhaled breath. The methods comprise selective reactive labeling of the chemical class of desired targets and specific isolation and detection of a desired subclass of or labeled targets.

In some embodiments there are provided methods for identifying and/or measuring an aldehyde in a sample, the methods comprise dispensing a labeling reagent solution on to a capture column, pushing a sample through the column, eluting the labeled sample with a methanol/water/HCl solution, dispensing the labeled sample solution onto a separating column, eluting the labeled aldehydes, and detecting labeled aldehydes in the solution.

In some embodiments there is provided a device which includes a capture column embedded with a labeling reagent, an elution solution, a light for inducing fluorescence, and a detector for measuring fluorescence emission, excitation, or absorbance.

In some embodiments the device receives a breath sample containing aldehydes from a subject, deposits the sample onto the capture column embedded with the labeling reagent, performs an elution process on the capture column to elute the labeled aldehydes, separates the aldehydes on a second column, measures the labeled aldehydes, and presents measurement results.

The labeled aldehydes can be isolated in bulk or as single species using normal phase, reverse phase and HILIC separation methods. In the reverse phase methods described herein, the labeled targets are separated by hydrophobic attraction to the separation substrate (matrix), e.g. a C2-C18 packed column. The more hydrophobic labeled targets are retained longer and elute with increasing organic content of the elution solution. The free unreacted label is more polar and elutes first and with appropriate choice of starting conditions; the free label and smaller aldehydes pass freely by the separation matrix. For HILIC separations, the mechanism of attraction is reversed with the more hydrophobic labeled targets eluting early and the less hydrophobic, smaller aldehyde, and free dye retained longer. In some embodiments, careful selection and matching of the labeling agent, target, separation matrix and separation conditions (solvent, pH, buffer (ion-pairing agent)) can be useful.

In some embodiments, the device comprises a fluorescence detection assembly that includes an emitter, a detector, a light chamber, a fluorescence chamber and a well, a light path that extends from the emitter, through the light chamber and through the well, and a fluorescence path that extends from the well, through the fluorescence chamber and to the detector.

In some embodiments, a method of detecting fluorescence includes exciting a solution containing fluorescently labeled CCM. The light passes through the solution and excites the fluorescently labeled moieties producing a fluorescence, and the fluorescence excitation or emission is detected.

In some embodiments, a method for identifying, detecting and/or quantifying CCM in breath includes (a) dispensing labeling reagent solution onto a capture column, (b) pushing the sample through the column, (c) eluting labeled sample with methanol/water/HCl solution, (d) dispensing labeled sample onto a separation column, (e) eluting the at least one carbonyl containing moiety from the separation column, and (f) detecting the labeled carbonyl containing moiety. In some embodiments, the detection is performed by (g) directing light within a predetermined wavelength range through the labeled sample solution, thereby producing a fluorescence, and (e) detecting the fluorescence.

### Target Capture

The system and methods provided herein are amenable to “real-time” assay formats for the detection of CCM, and can be applied to the detection of CCM in solution, and/or the detection of trace CCM in the gas phase by the addition of a primary capture (on a substrate) and release (elution from the loaded substrate) process.

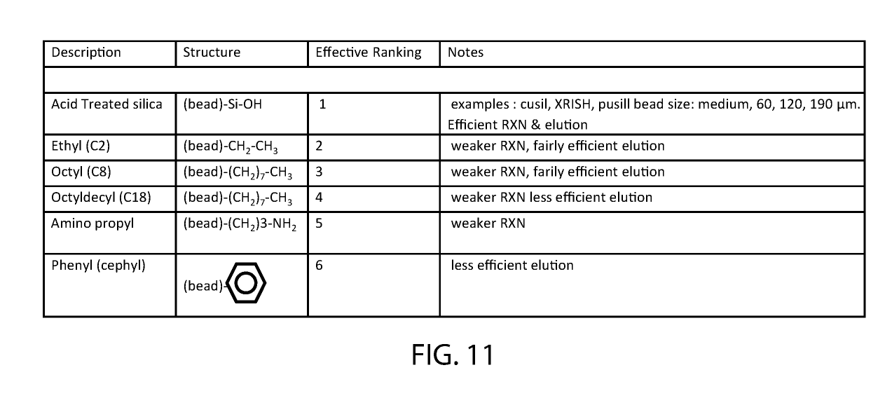

In one embodiment of the process, the labeling agent is deposited on a substrate such as acid treated silica, ethyl (C2), octyl (C8), octyldecyl (C18), amino propyl or phenyl (cephyl) (see FIG. 11) and dried.

The sample containing the target compounds, e.g. the CCM, is pushed through the substrate and reacts with the labeling agent. In some aspects, the substrate is a “capture column”.

In another embodiment of the process, the labeling agent is deposited on a substrate such as Porex (POR-4903) and dried.

In some aspects, a further substrate, such as a capture column, is stacked on top (or first in the series) to the substrate embedded with the labeling reagent. As such, the capture column could have two substrates, a top substrate having no labeling reagent contiguous with another substrate having a labeling reagent.

A gas phase CCM, for example, aldehydes from the breath of a human, are pushed through the capture column. An elution solution is dispensed into the stacked substrates to remove CCM retained on the capture column and to flow the CCM into contact with the labeling reagent embedded (or deposited on) the Porex substrate, for example. The labeling reagent dissolves and reacts with the CCM in solution, e.g. the reaction solution.

Additional substrates can be added in a series to the capture column, for example, a catalyst embedded (or deposited) on a substrate, a buffer embedded (or deposited) on a substrate, one or more standards embedded (or deposited) on a substrate, and calibrants embedded (or deposited) on a substrate. In some embodiments, each substrate supports a different component of the reaction; in some embodiments, a given substrate supports two or more components of the reaction. Typically, the stack order or series order can be as follows: CCM capture substrate, buffer substrate, calibrants substrate, catalyst substrate, and reactive dye substrate. In some embodiments, the embedded substrates are dried before stacking. In some embodiments, the substrates in a given stack are the same material. In some embodiments, at least one of the substrates in a given stack is a different material than the other substrates.

In some embodiments, the capture column (substrate) comprises a material selected from the group consisting of glass, silica, polyethylene, Teflon, x9908, por-4903, polypropylene, and mixtures thereof.

In some embodiments, the capture column comprises acid activated silica.

The CCM or aldehydes can be removed from the capture column using any elution solution appropriate for the chemistry provided herein. An exemplary elution solution comprises methanol/water/HCl where the HCl is present in an amount of about 0.1% to about 2.0% by volume.

### Reactive Labeling Agents

Exemplary reactive labeling agents (also referred to herein as labeling reagents) provide both selective and rapid labeling as well as single carbon separation. One illustrative reactive labeling agent, ao-6-TAMRA, comprising 6-TAMRA (6-tetramethylrhodamine), cadavarine, and aminooxy, provides rapid and selective coupling to carbonyl groups with aldehyde>>ketone reactivity. The resulting oxime bond is more stable than complementary hydrozone bonds formed with hydrazine and hydrazide chemistry which require reduction to secondary amine linkage increased stability. Hydrozones are subject to scrambling due to re-equilibration.

The reactive labeling agent contains three aspects which are varied for a given application. The parent fluorophore, for example, TAMRA, defines the detection modality and primary separation mechanism. The linker modulates the separation mechanism and quantum yield. For example substitution of the diamine alkyl linker for a more polar water soluble polyethylene (PEG) linker results less retention on reverse phase hydrophobic separation. The PEG linker restricts the volume that can be loaded due to band broadening as a result of lower affinity for the separation matrix compared to the alkyl diamine linker. The last element, the reactive group, modulates specificity, rate and label stability.

Typically, a reactive labeling agent can selectively and efficiently (rapidly) label the target carbonyls, can provide for bulk and individual separation from the unreacted reagent, and can provide adequate detection properties for spectroscopic detection.

Three structural aspects, described above, of the reactive labeling agent can be varied to provide options for labeling when varying the solvents, reaction times and temperatures, and column length.

The fluorophore can affect the detection and separation of the target carbonyls.

The linker can affect separation mechanism and quantum yield.

The reactive group can affect specificity, reaction rate, and label stability.

Thus, in some embodiments, the reactive labeling agent comprises a fluorophore, a linker, and a reactive group.

In some embodiments, the fluorophore is tetramethyl rhodamine (TAMRA), rhodamine X (ROX), rhodamine 6G (R6G), or rhodamine 110 (R110). In some embodiments, the fluorophore is aminooxy 5(6) TAMRA, or aminooxy 5 TAMRA, or aminooxy 6 TAMRA. In some embodiments, the fluorophore is a fluorescent hydrazine or aminooxy compound.

In some embodiments, the labeling reaction is selective for carbonyl functional groups: aldehydes and ketones with reactivity much greater for aldehydes than ketones (aldehyde>>than ketone). The reaction forms a stable oxime bond. Hydrazine and hydrazide reactive groups also provide selective labeling of carbonyls.

The nature of the fluorophore, TAMRA isomer, linker, and reactive group can modulate the reactivity as well as separation properties of the reactive labeling agent. However, other aspects of the reaction and separation processes can be modulated to achieve desirable reaction rates and efficiencies, including, for example, buffer (pH), fluorophore concentration, or organic solvent.

The reactive labeling agent can comprise a mixture of ao-TAMRA isomers modified according to the description provided herein: for example, ao-5-TAMRA and ao-6-TAMRA. This mixture can vary in isomer ratio depending upon the synthesis and purification methods used. Use of the mixed isomer formulation yields a complex chromatograph: two bands for each aldehyde, one for each isomer. Resolution between individual aldehydes can be more difficult due to isomer overlap, though modification of the solvent system or column characteristics can reduce isomer separation but permit aldehyde resolution. Use of a single isomer formulation yields a less complex chromatograph than the mixed isomer formulation. The reactive labeling agent comprising the ao-6-TAMRA isomer is less retained in this method and allows for a shorter run time (less than 15 minutes) and better resolution of longer chain aldehydes than does the reactive labeling agent comprising the ao-5-TAMRA isomer (more than 15 minutes).

Reactive labeling agents comprising aminooxy-5(6)-TAMRA can react with aldehydes or ketones to form a stable oxime compound under mild conditions.

The concentration of the reactive labeling agent can be varied to achieve a desired fluorescence. In some embodiments, the reactive labeling agent concentration varies from 0.5 μM to 20 μM, or is approximately 10 μM.

### Linkers and Reactive Groups

As mentioned previously, a linker can affect separation mechanism and quantum yield. For example, substitution of a diamine alkyl linker for a more polar water soluble polyethylene glycol (PEG) linker can result less in retention on reverse phase hydrophobic separation. Illustratively, a reactive labeling agent comprising ao-PEG-5-TAMRA is less retained on reverse phase chromatography than the corresponding reactive labeling agent comprising ao-TAMRA with a hydrophobic linker: 6 min versus 11 min (40% MeOH initial), respectively.

Even though adequate separation can be achieved using a 5% to 100% methanol gradient, the PEG linker restricts the volume that can be loaded onto a reverse phase column due to band broadening as a result of lower affinity for the separation matrix compared to an alkyl diamine linker. Appreciable band spreading can occur when the injection volume is increased from 10 μL to 100 μL.

Reactive labeling agents comprising ao-6-TAMRA can be present in injection volumes from 10 to 900 μM and still provide suitable separation and minimal to no band broadening.

Exemplary linkers include substituted alkyl-diamines (C2-C10), substituted amino-carboxylic acids (C2-C10), and substituted polyethylene glycols (N=1-10). In some embodiments, the linker is selected from the group consisting of hexanoic acid, aminohexanoic acid, cadavarine, polyethylene glycol, and polyglycol.

The reactive group provides specificity, rate of reaction, and label stability. For example, an aminooxy reactive group provides rapid formation of a stable oxime bond with carbonyl function groups and is considerably faster than hydrazide couplings. The initial rate can be accelerated at elevated temperatures (2× at 40° C.). Likewise, the reaction exhibits a pH profile with increasing reaction rate between pH 5 and pH 2.4. The rate at pH 4.2 is approximately 10× of the rate at pH 7.

In some embodiments, the reactive group can be selected from the group consisting of a hydrazine moiety, a carbohydrazide moiety, a hydroxylamine moiety, a semi-carbazide moiety, an aminooxy moiety, and a hydrazide moiety.

As such, compounds useful herein comprise a fluorophore, a linker, and a reactive group. In some embodiments, the fluorophore is TAMRA, is aminooxy-5-TAMRA, is aminooxy-6-TAMRA, or is a mixture of aminooxy-5-TAMRA and aminooxy-6-TAMRA. In some embodiments, the linker is selected from the group consisting of hexanoic acid, aminohexanoic acid, cadavarine, polyethylene glycol, and polyglycol. In some embodiments, the reactive group is selected from the group consisting of a hydrazine moiety, a carbohydrazide moiety, a hydroxylamine moiety, a semi-carbazide moiety, an aminooxy moiety, and a hydrazide moiety.

In some embodiments, the compound is selected from the group consisting of:

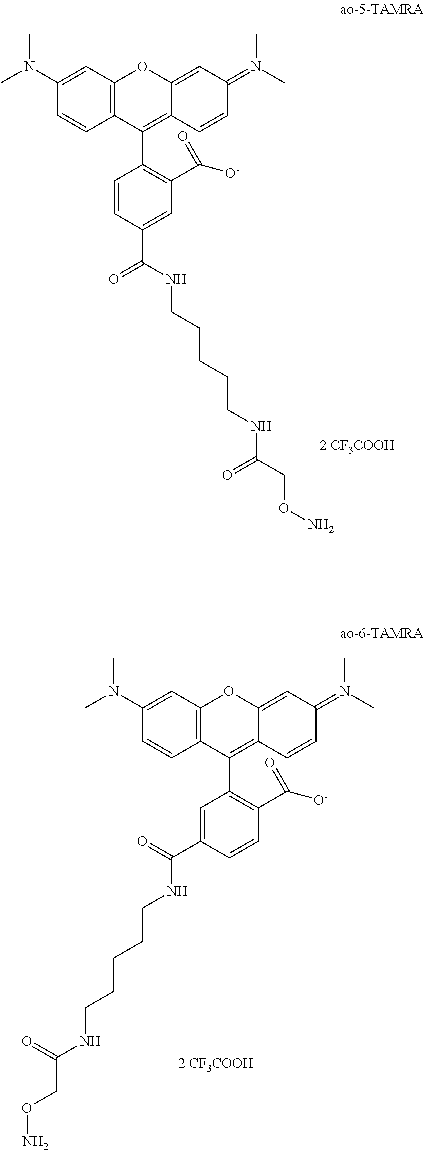 [SMILES: CN(C)c1ccc2c(-c3ccc(C(=O)NCCCCCNC(=O)CON)cc3C(=O)[O-])c3ccc(=[N+](C)C)cc-3oc2c1 ; CN(C)c1ccc2c(-c3cc(C(=O)NCCCCCNC(=O)CON)ccc3C(=O)[O-])c3ccc(=[N+](C)C)cc-3oc2c1]

and mixtures thereof.

### Standards

In some embodiments, standards are included in the assay. Standards can ensure consistency and can provide assurance that a given assay is functional and providing accurate data. In particular, reactive and non-reactive standards are contemplated as useful herein. Internal standards should not interfere chromatographically with target molecule. Using standards, the limit of detection (LOD) for a given method can be determined.

A reactive standard can provide a mechanism for correcting signals for drift in reactivity that could be caused by a number of factors including: reagent degradation (fluorophore, catalyst, buffer), dispensing variations, and environmental variations (temperature). Long chain aliphatic aldehydes can be selected and screened for the reactive standard.

A non-reactive standard can provide for normalization of signals due to instrument drift or variance, a measure of overall reactivity, and retention time registration. In some embodiments, a non-reactive standard is stable under the conditions employed, i.e. does not undergo reactive or passive exchange with the reagents (i.e. labeling reagent, target, catalyst, or other aldehydes). The non-reactive standard must be stable spectroscopically and chemically under the conditions of the assay. This requires special consideration in the selection and construction of a non-reactive standard. For the non-reactive standards, amide functionalized 6-TAMRAs can be prepared. Illustrative compounds include 6-TAMRA-C14, 6-TAMRA-C16, and 6-TAMRA-C18.

For example, combining an aldehyde functionalized 6-TAMRA in solution containing an aldehyde, e.g. a molecule that will react with the labeling reagent (an amino oxy with a carbonyl group), an exchange will happen between aldehydes such that non-intentional standards would be generated. As such, a TAMRA derivative with a stable peptide linkage was conceived for the purpose of avoiding exchange between non-reactive standards and other aldehydes present in the system.

In some embodiments, a reactive or non-reactive standard compound does not interfere with the target compounds, for example, with C4-C10 aldehydes. In some embodiments, the reactive or non-reactive compounds are well resolved from one another.

In some embodiments, the reactive standard compound has suitable reactivity for the assay. In some embodiments, the non-reactive linkage is stable to the reaction conditions.

### Description of the Process

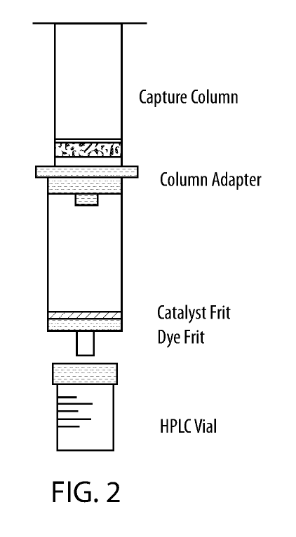

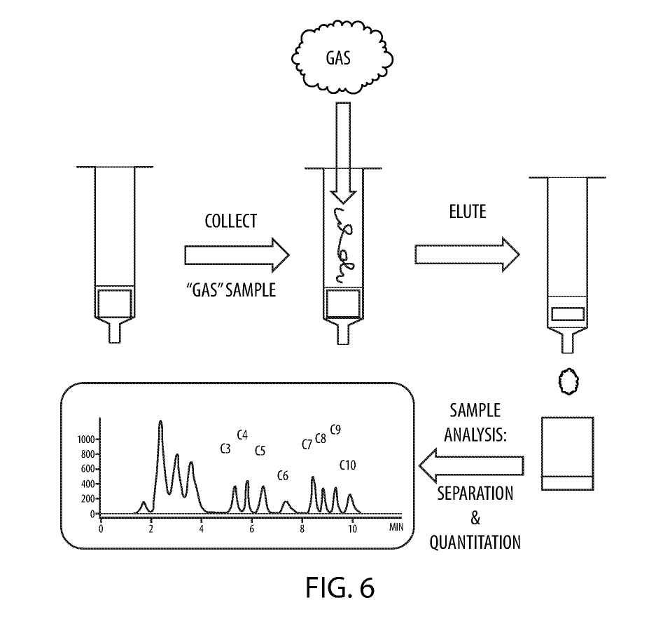

The methods and systems disclosed herein are illustrated in FIGS. 2 and 6, which will be described in greater detail below. Samples containing CCM such as aldehydes are deposited onto a substrate embedded with labeling reagent. The CCM react with the dye to form labeled CCM which are subsequently eluted from the substrate (capture column) with methanol/water/HCl elution solution.

### Elution:

Following heterogeneous labeling on silica, for example, labeled CCMs such as aldehydes are effectively eluted with acidified organic water solvent system. Methanol/water/HCl solutions, 50-100% methanol and HCl in an amount of about 0.1 to about 1%, were found to be particularly effective in removing labeled aldehydes in a small elution volume. Other water miscible organic solvents such as acetonitrile (ACN, MeCN), ethanol (EtOH), 2-propanal (IPA), and mixtures thereof can also be used and are contemplated herein. The sample can be diluted—once the labeling reaction is done, water or buffer can be added to the system. For example, instead of using 70% methanol, 100% methanol can be used to elute the labeled CCM in a small volume, then the sample solution can be diluted as needed for detection. Stronger eluents include isopropyl alcohol, acetonitrile, ethanol, dimethyl formamide, dimethyl amide, and n-methylpyrrolidone, but these eluents should be used in a column equilibrated with very little organic solvent so as to provide a dilution effect.

### Separation

The solution containing the labeled CCM, e.g. aldehyde, is then injected into a separator column, for example, a C18 reverse phase separation column which has been pre-equilibrated with a low to moderate organic content solvent/buffer mixture such as 45% MeOH/TEA pH 7. Following injection, the sample is subject to gradient of increasing organic solvent content. The gradient can be linear (about 40% to about 100% methanol, for example), stepwise or a combination (step plus linear). A typical gradient process can be initial pre-equilibration 45% MeOH/TEA pH 7; followed by hold 2-4 mins; followed by linear increase over 10 mins from 45%/MeOH pH 7 to 100% MeOH; followed by rapid return to the initial conditions (45% MeOH/TEA pH 7). During this process, labeled CCM (labeled target) elute from the column based on the combined hydrophobicity of the target/label. For example, for those labeled with ao-6-TAMRA, the elution order is from smaller chain aldehydes to larger chain aldehydes (C3, C4, C5 . . . C10). Organic water miscible solvents such as acetonitrile, methanol, ethanol, 2-propanol, and mixtures thereof can be used for the organic mobile phase. The aqueous phase or component can be water or buffer at a pH of about 6 to about 7. Typical buffers include triethylamine acetate (TEA), trifluoracetic acid (TFA), acetic acid, and formic acid. Separation can be performed using linear, stepwise, or piecewise (mix of linear and stepwise), using parabolic gradients or using isocratic (static organic/aqueous) methods. Using the elution solution containing a TAMRA derivative as an illustrative example, the labeled CCM is eluted and detected by measuring the fluorescence absorbed or emitted by the TAMRA derivative attached to the CCM.

The CCM content is quantitated by monitoring the signal for each eluting species, e.g., each aldehyde species. The signal is a function of the initial CCM concentration. With continuous flow detection which is synchronized with the elution gradient the signal is monitored as a function of time following injection. The signal intensity and area reflects the population of each labeled species (e.g., labeled aldehyde). Quantitation for each species in a sample is by reference to a standard curve generated by injection of known quantities of synthesized labeled-CCM standards. CCM such as aldehydes can also be quantitated using a discontinuous flow detection where labeled species are step-wise eluted and the fluorescence signal measured for each group using standard fluorimeter or similar device. The quantitation process described is an example of “end-point” assay scheme. In this scheme the assay is allowed to incubate for a set time and then analyzed. The conversion or signal increase is a function of the initial carbonyl (target) concentration. There are two general assay format or detection modes. They are generically described as end-point and kinetic. In an end-point assay the system is incubated for a set time and the signal is read. The signal at that point reflects the amount of analyte in the system. For a positive assay, the greater the concentration of the analyte, the greater the signal increase. In a kinetic assay the rate of change is monitored for a set duration. The rate of change is correlated to the amount of analyte. In some aspects, the end-point assay is employed with the methods provided herein.

In another embodiment, labeled CCMs are grouped into classes. The number of classes depends on the number of different rinses used. In an SPE type of format, one, two or three rinses are used to separate short chain (C1-C3), medium chain (C4-C7) and long chain (C8-C10) labeled aldehydes. The groups can be quantitated based on fluorescence signal using either a continuous or discontinuous flow method as describe above. One of the benefits of this second embodiment is that it provides a rapid assessment of total aldehydes and target groupings of aldehydes. This can facilitate rapid screening processes.

In some aspects, the systems and methods permit a user the ability to resolve and identify individual molecules that differ by one carbon in chain length. Illustratively, the labeled CCM are captured on a separation filter assembly or separation column. The labeled CCM are then eluted by gradient to allow resolution and detection of CCM differing by a single carbon in chain length.

The desired labeled CCM can be isolated and separated from unreacted label and interfering species using reverse phase (RP), normal phase (NP), ion exchange (IC), and or hydrophilic (HILIC) chromatography. The desired species can be isolated individually for analysis and quantitation or as groups of species. For example, using moderate size C18 matrices (nominal 40-60 μm particles), C4-C10 linear alkyl carbonyls can be isolated form the unreacted label and smaller linear alkyl carbonyls (C1-C3) using a two-step elution process, for example, 40% MeOH followed by a 90% MeOH elution. In this example, desired species are group analyzed as a sum of species. Individual alkyl aldehydes can be isolated and analyzed using smaller bead size C18 matrices (10 μm) using a linear, step, or piece wise (step followed by linear) gradient. For example, in an embodiment provided herein, individually labeled CCM are isolated and analyzed employing reverse phase separation using a column containing 10 μm C18 particles using a 45% to 90% MeOH piece wise gradient at moderate pressures (≈700 psi).

### Detection

Labeled carbonyl species are detected, analyzed, and quantitated by direct light, within a predetermined wavelength range through the solution, thereby producing fluorescence. The fluorescence is detected, analyzed and quantitated within a predetermined wavelength range. For example, when using aminooxy-5(6)-TAMRA, the λ_{Ex}/λ_{Em}(in MeOH) is 540/565 nm; when using aminooxy-5(6)-ROX, the λ_{Ex}/λ_{Em} (MeOH) is 568/595 nm.

Analysis can be performed in a static mode (bulk quantitation) or in a flowing mode (individual analysis) as a function of time as the solution is eluted from the separation matrix and passes the detector window, or via a hybrid flow and stop mode.

In some embodiments, the step of detecting the CCM comprises measuring fluorescence emission produced by excitation of the fluorophore. In some embodiments, the step of detecting the CCM comprises measuring fluorescence absorbance produced by excitation of the fluorophore. In some aspects, the step of detecting the CCM comprises directing light within a predetermined wavelength range to the labeled CCM, thereby producing a fluorescence, and detecting the fluorescence. In some aspects, the concentration of the CCM is determined by calculating the fluorescence excitation (absorption) or emission relative to a standard curve, wherein the fluorescence signal is proportional to the concentration of the CCM.

As described, the reactive label and corresponding labeled aldehydes can be isolated and separated using a manual SPE format process or by rapid chromatography using semi-prep or analytical short columns. The labeled aldehyde targets are loaded onto a standard conditioned SPE column. Two rinses are employed. The initial rinse releases unreacted label, C1, C2 and C3 labeled aldehydes into one fraction. A final rinse of high organic content results in release of longer chain aldehydes. These include C5-C10. The carryover is <4% in this example. The C5-C10 can be quantitated optically (absorbance or fluorescence) to provide a sum of aldehydes in the sample. The grouping can be modulated by varying the formulation of the rinses.

A more surprising attribute is the ability to rapidly isolate and quantitate trace levels of aldehydes which differ by signal carbon chain lengths using semi-prep chromatography medium 10-15 μm particle C18. For example, single carbon resolution and detection can be illustrated using a 4.6×30 mm and 4.6×50 mm column containing 10 μm materials as moderate pressures in less than 15 minutes.

The method provides for rapid detection and quantitation of trace levels of alkyl aldehydes. Sub-picomoles of aldehydes can be quantitated following 15 minutes of incubation and separation, with a total time approximately 35 minutes. Employing a reactive and nonreactive internal standard pair for correction of reaction efficiency an LOD of <0.13 pico mole can be observed.

Optically, labeled aldehydes can be detected down to 1 to 10 femto moles depending upon the sensitivity of the detector. Very trace levels of aldehydes can be detected by extending the incubation time and increasing the column length to provide for additional resolution.

A reactive labeling agent comprising ao-6-TAMRA in combination with a buffer and catalyst can detect and quantitate aldehydes in breath samples. In the examples provided fluorescence emission detection is employed. Aldehyde labeling and identification was confirmed by LCMS analysis (data not shown). As a corollary, the labeling scheme is amenable to dual Fl/LCMS detection or single Fl and mass spec detection modalities.

Furthermore the methods and systems provided herein are amenable to both biological and environmental samples for trace aldehyde targets of interest. The disclosure is not limited to solution or gas (air) based sampling but can be adapted to other samples for use of real time application or point of care applications and provide data within 1 hour post sampling.

In some embodiments, the method for detecting the presence of at least one carbonyl containing moiety in a sample, comprises the steps of:

(a) dispensing buffer in solution on to a solid substrate and drying the substrate;

(b) dispensing catalyst in solution on to a solid substrate and drying the substrate;

(c) dispensing reactive labeling reagent in solution on to a solid substrate and drying the substrate;

(d) layering a solid capture substrate, the substrate from (a), the substrate from (b), and the substrate from (c) in series;

(e) pushing the sample through the column, where the at least one carbonyl containing moiety is captured by the solid capture substrate;

(f) eluting the carbonyl containing moiety with an organic solvent solution selected from DMF, DMSO, ethanol, acetonitrile, water miscible solvent, n-methyl pyrrolidone, and methanol/water/HCl solution, whereby the carbonyl containing moiety, the buffer, the catalyst, and the reactive labeling reagent form an elution/reaction solution;

(g) incubating the elution/reaction solution to obtain at least one labeled carbonyl containing moiety;

(h) dispensing the solution containing at least one labeled carbonyl containing moiety onto a separation column;

(i) separating the labeled carbonyl containing moiety using isocratic methods or changing gradients (linear, stepwise, piecewise, or parabolic), using methanol or water miscible solvent and water and/or buffer; and

(j) detecting at least one labeled carbonyl containing moiety in the solution.

In some embodiments, the method for detecting the presence of at least one carbonyl containing moiety in a sample comprises the steps of:

(a) dispensing reactive labeling reagent in solution on to a capture column and drying the column;

(b) pushing the sample through the column;

(c) eluting labeled sample with an organic solvent solution selected from DMF, DMSO, ethanol, acetonitrile, water miscible solvent, n-methyl pyrrolidone, and methanol/water/HCl solution;

(d) dispensing labeled sample onto a separation column;

(e) separating the labeled carbonyl containing moiety using isocratic methods or changing gradients (linear, stepwise, piecewise, or parabolic), using methanol or water miscible solvent and water and/or buffer; and

(f) detecting at least one labeled carbonyl containing moiety in the solution.

In some embodiments, the method for detecting the presence of at least one carbonyl containing moiety in a sample comprises the steps of:

(a) dispensing buffer in solution on to a solid substrate and drying the substrate;

(b) dispensing catalyst in solution on to a solid substrate and drying the substrate;

(c) dispensing reactive labeling reagent in solution on to a solid substrate and drying the substrate;

wherein one or more of the buffer, the catalyst, and the reactive labeling agent are dispensed onto the same solid substrate, and layering a solid capture substrate in series with the substrates of (a), (b), and (c);

(d) pushing the sample through the column, where the at least one carbonyl containing moiety is captured by the solid capture substrate;

(e) eluting the carbonyl containing moiety with an organic solvent solution selected from DMF, DMSO, ethanol, acetonitrile, water miscible solvent, n-methyl pyrrolidone, and methanol/water/HCl solution, whereby the carbonyl containing moiety, the buffer, the catalyst, and the reactive labeling reagent form an elution/reaction solution;

(f) incubating the elution/reaction solution to obtain at least one labeled carbonyl containing moiety;

(g) dispensing the solution containing at least one labeled carbonyl containing moiety onto a separation column;

(h) separating the labeled carbonyl containing moiety using isocratic methods or changing gradients (linear, stepwise, piecewise, or parabolic), using methanol or water miscible solvent and water and/or buffer; and

(i) detecting at least one labeled carbonyl containing moiety in the solution.

In some embodiments, a column is provided comprising a solid substrate and a reactive labeling reagent embedded onto the substrate.

The following examples of the heterogeneous chemistry detection methodologies illustrate different configurations that can be constructed and utilized.

### EXAMPLES

The following examples are provided for illustrative purposes only and are not intended to limit the scope of the invention.

### Example 1: The FRIT Method

The Frit method is based on changing the presentation by using different matrices for containing and presenting the reactants in the solid phase. In this method, the reactive dye (i.e. the reactive labeling agent), catalyst, and buffer are deposited on individual frits or membranes that weakly but sufficiently hold the reagent while allowing the reagent to be easily dissolved and removed. The individual reagent containing “frits” are then arranged with the capture matrix to form a “stacked” ordered reactive sandwich (FIG. 2). FIG. 2 shows a schematic of a capture column 200, column adapter 202, and stacked frits 204(catalyst) and 206 (dye) attached to a HPLC vial 208. The stack order preserves the solution reaction addition order that is required: aldehyde, buffer, calibrants, catalyst, and reactive dye. The elution solution for the aldehydes flows through the capture column 200 or cartridge releasing the target analytes. Then the analyte solution flows through the reagent containing “frits” 204, 206. The reagents dissolve forming an elution/reaction mix. Reaction on the surface as well in solution can take place in this process. It may be best described as a solution reaction but without the solution reagent additions. Different types of frits and membranes are contemplated herein.

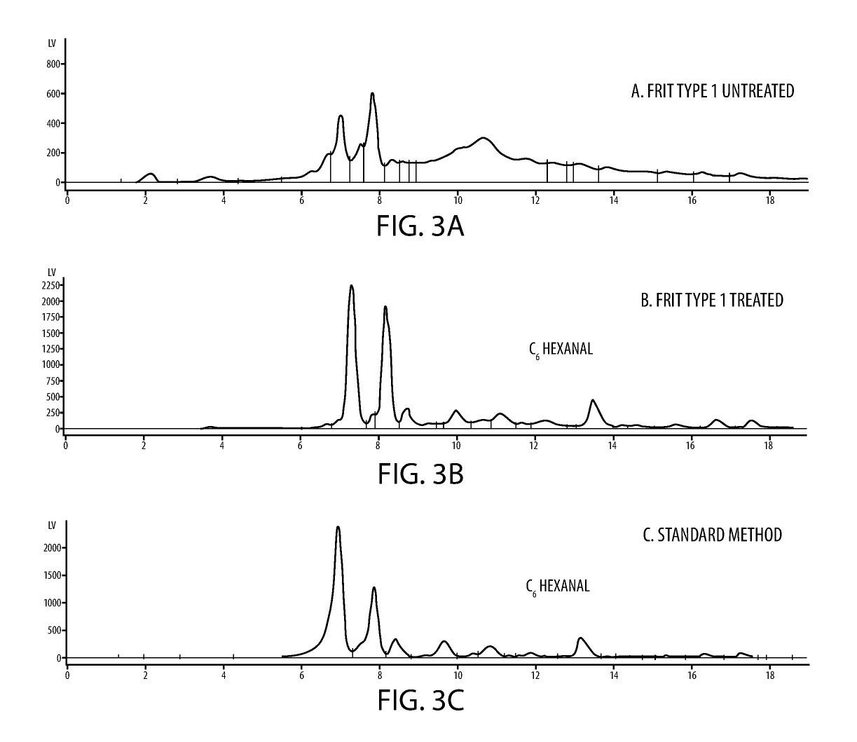

The data shown in FIGS. 3A, B, and C was obtained by using a Porex, POR-4903 hydrophobic frit as a substrate for the catalyst and dye. Circular frits were cut from the main sheet of material and spiked with enough Catalyst or Dye (46.8 mM 5-MethoxyAnthranillic Acid in methanol or 0.1103 mM 6-ao-TAMRA in acetonitrile) to completely cover the circular frit and produce the desired final concentration upon elution, 4 mM and 6.8 μM, respectively. The disks were dried at ambient temperature and pressure overnight. The reaction efficiency was then compared to the standard manual solution addition reaction method for gas aldehyde capture. In this evaluation, 300 mg CUSIL (silica) SPE, United Chemical Technologies, was used for gas aldehyde capture. Prior to use, the columns were cleaned, dried and conditioned using the standard development methodology, 5 mL of 99% methanol-1% HCl solution, followed by 2×5 mL rinses of methanol. Columns were dried for 45 minutes under with 45 PSI purified N₂ gas. Columns were spiked with 1757 picomoles of humidified C6 gas, 37° C., 12 ml/min with N₂ carrier gas.

The standard result 300 of a typical solution method is displayed in FIG. 3C (as described in a method like that of FIG. 1). The chromatograph 302 obtained by deposition of the catalyst and reactive dye as described above on to frit materials as received is displayed in FIG. 3A. The chromatograph exhibits significant distortions 304 which lead to obscuring of the expected C6, hexanal peak 306. Pretreatment of the frits using an acidified methanol solution followed by methanol rinse and drying can mitigate or eliminate this distortion 308, see FIG. 3B. The peak shapes are greatly improved and much of the tailing has been removed. The C6, hexanal intensity (area) 306 observed is comparable to the solution based standard method (FIG. 3C).

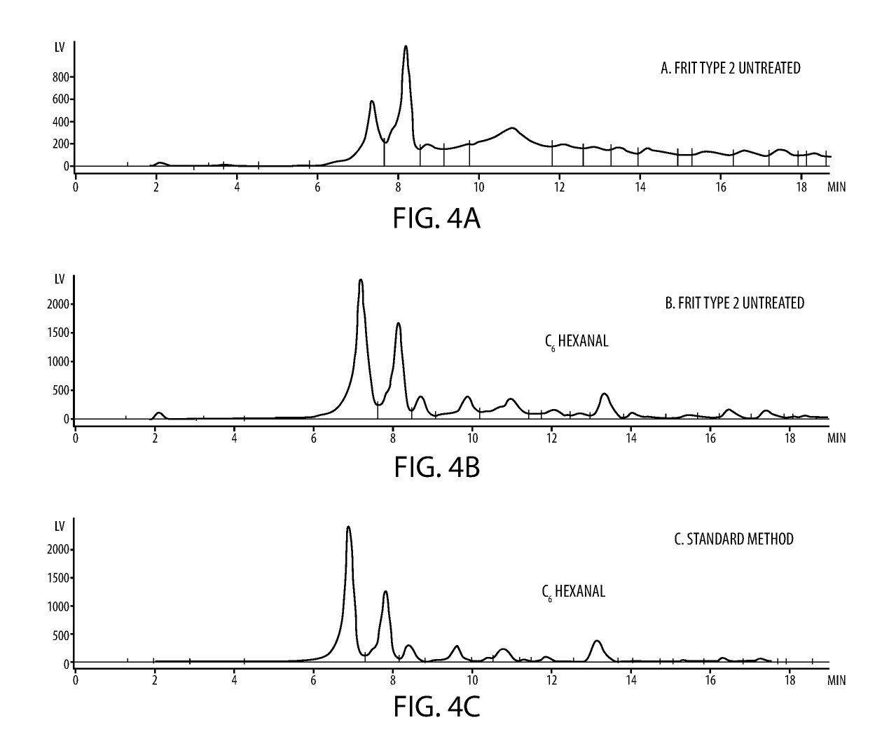

Similar observations are observed for type 2 Frit materials (FIGS. 4A, B and C). As shown in FIG. 4A, prior to pretreatment, the chromatograph 400 shows significant chromatographic distortions 402, as was seen in FIG. 3A. After pretreatment, the chromatograph 404 shows that the distortions appear to be removed and results comparable to the standard solution method are observed (see hexanal peak, 406), as shown in FIG. 4B. FIG. 4C illustrates a typical solution method chromatograph 408.

Both examples shown in FIGS. 3A-C and 4A-C indicate that the sandwich method using a solid state disposition of the catalyst and reactive labeling reagent yield comparable performance as the standard solution method, without the need for secondary dispensing of reagents. By proper formulating of the reagents and combining the buffer and elution reagents into a single solution, the assay reaction process can be converted into a single step process.

### Example 2: The Column Method

The column method combines capture with reaction. An effective methodology provides not only that the matrix captures the desired analyte but that the reaction is efficient and complete on the surface and the resulting labeled analyte can be efficiently removed from the capture reaction matrix for analysis. Efficient removal of the labeled analyte can be a significant challenge. This suggests a balance of matrix affinity and elution formulation. The reactive label must be stable on the matrix and adequately adhere to provide for capture. Inadequate adherence would limit the labeling content on the matrix. If the adherence or affinity is too strong then removal of the labeled material would require very stringent conditions or large volumes of eluting solution which in turn would severely dilute the sample and restrict sensitivity of the assay. In the course of the development, a menu of matrices and elution formulations were examined (see Table 2). For the sake of brevity, the discussion and examples which follow focus on the use of acid treated silica matrices.

TABLE 2
Solid Matrix Materials Examined for Heterogeneous Labeling

| | | Effective | |
|---|---|---|---|
| Description | Structure | Ranking | Notes |
| Acid | (bead)- | 1 | examples: cusil, XRISH, |
| Treated | Si—OH | | pusill bead size: medium, |
| Silica | | | 60, 120, 190 μm. |
| | | | Efficient reaction and elution |
| Ethyl (C2) | (bead)- | 2 | weaker reaction, fairly |
| | CH₂—CH₃ | | efficient elution |
| Octyl (C8) | (bead)- | 3 | weaker reaction, fairly |
| | (CH₂)₇—CH₃ | | efficient elution |
| Octyldecyl | (bead)- | 4 | weaker reaction less |
| (C18) | (CH₂)₇—CH₃ | | efficient elution |
| Amino | (bead)- | 5 | weaker reaction (unoptimized) |
| propyl | (CH₂)3—NH₂ | | |
| Phenyl | (bead)- | 6 | less efficient elution |
| (cephyl) | | | |

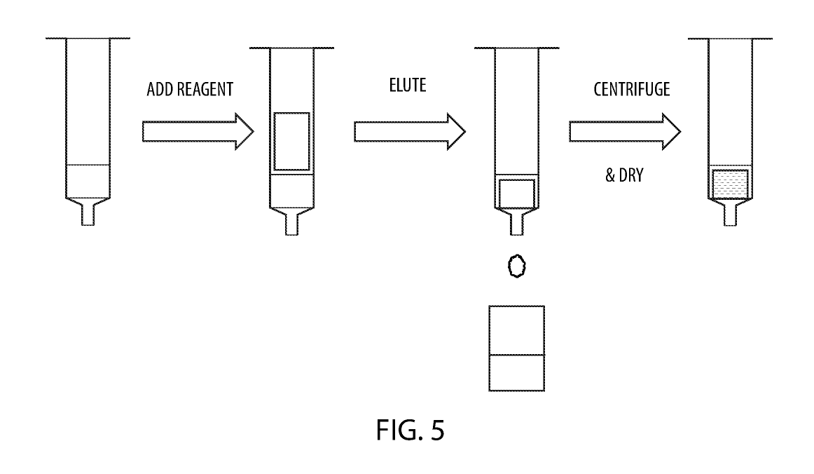

Column Preparation. The steps are shown in FIG. 5, though deviations are contemplated as long as the overall purpose is accomplished 500. Pretreatment of the column is required to remove impurities which interfere with sample analysis 502. The labeling stock solutions were prepared with a semi-volatile organic solvent such as methanol or acetonitrile. For 6-ao-TAMRA, acetonitrile solutions provided greater stability and less interference with decomposition products. Though the solution reaction was more efficient at acidic pH, acidification of the stock solution during preparation was found to significantly reduce the stability and reactivity of the heterogeneous method. This is presumably due to pre-activation of the labeling reagent and subsequent activation of alternative reaction routes and decomposition processes. The basic steps for column preparation are:

Pretreat Column 502:
Treat with 3 to 5 bed volumes 1% HCl-MeOH, i.e. 3 to 5 mL.
Rinse with 6 to 10 bed volumes of MeOH, i.e. 2×3 mL.

Load Column with Reactive Dye Solution 504:
500 μL of 300 μM 6-ao-TAMRA solution for 150 mg bed (150 nmoles reactive labeling agent).

Elute reactive dye solution through the column bed 506.

Remove excess solution by centrifugation at 2000 rpm for 8 minutes, and dry 508.

The general experimental design 600 or scheme involving comparison of the different versions of the heterogeneous methodology to the standard method developed for labeling of gas and solution aldehydes is outlined in FIG. 6.
1. Prepared heterogeneous reactive columns 602 were exposed to humidified gas of set concentration and volume 604.
   i. Gas samples were humidified by passing of N₂ or Air delivery through a water bath at 37° C. Gas temperature was maintained at 37° C. via tube heating coils and wrap.
   ii. Gas mixtures were obtained by an specialized evaporation apparatus, internally designed to compensate for differences in volatility of different aldehydes.
   iii. For single hexanal exposures, purified gas from commercial suppliers was employed.
   iv. Gas mixtures and concentrations were produced by dilution into carrier gas via a series of Omega gas mass controllers.
2. Following sample collection the exposed labeling reagent was eluted from the column via a series of solution rinses 606.
3. Each rinse was analyzed for reaction conversion and elution efficiency via HPLC 608.

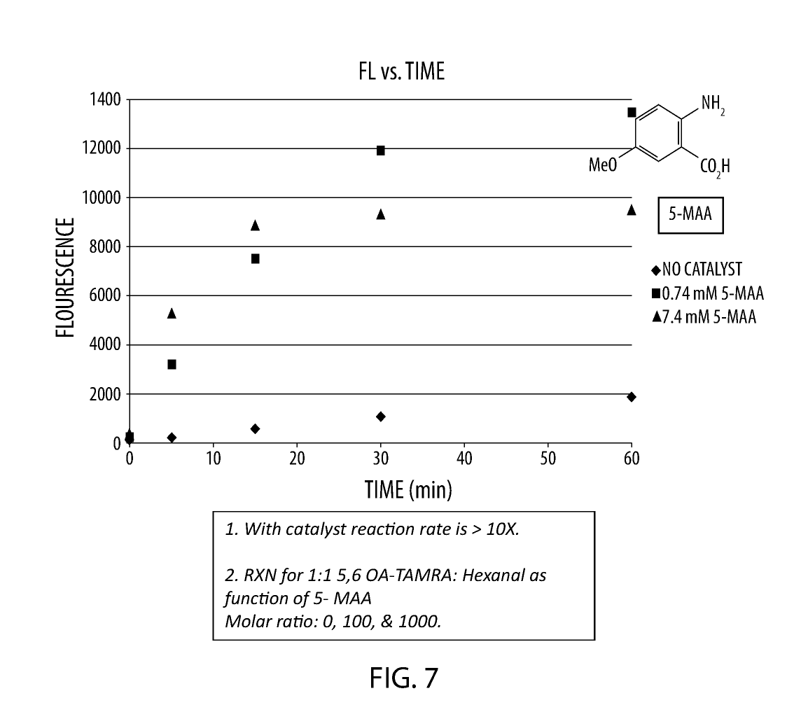

In the standard method, gas phase aldehydes were captured via a matrix, i.e. silica, and then eluted from the matrix by water:organic solutions (H₂O:MeOH). Labeling was performed by the addition of buffer, catalyst, and reactive labeling agent. The order of addition prevents pre-activation of the labeling agent and loss of reactivity. Contact between the catalyst and reactive labeling reagent is typically limited. The order of addition can be described by this simple shorthand, ABCD: aldehyde, buffer, catalyst, dye. A catalyst is employed at an excess molar ratio to increase the reaction rate. The reaction can be performed without a catalyst but requires extended incubation times (see FIG. 7). The incubation time is dependent upon the amount of analyte present. Completion typically takes more than 90 minutes at low aldehyde concentrations, and in the absence of catalyst for convenience, the sample is often allowed to incubate overnight. The standard method is applicable to gas and solution samples of aldehydes.

To mimic breath conditions, gas aldehyde capture experiments employ humidified aldehyde gas samples. Samples were humidified at 37° C. by passing a diluted gas sample through a water bath. Gas temperature was maintained at a constant 37° C. via a heated gas mantel. Gas samples of aldehydes at specific concentrations are generated by dilution with a carrier gas (purified N₂ or air). Concentration and flow are controlled using a series of Omega mass controllers. For single aldehyde gas control/standard samples, purified aldehyde gas was obtained from commercial suppliers. Commercial aldehydes were limited to lower molecular weight small carbon chain aldehydes. Hexanal which occupies the middle range is commercially available and is used as the standard for most gas phase experiments. Aldehyde mixtures were prepared by evaporation via an apparatus internally designed to factor in the differences in aldehyde volatility as a function of chain length. Carrier gas was delivered to the column at a rate of 3 L/min. For a 10 L sample, the exposure time was approximately 3½ mins.

The Basic Experimental Scheme:
1. Collect gas sample of known quantity of gas aldehyde on control column (standard capture column) and on “heterogeneous” column (column containing reactive label).
2. Elute sample with various formulations and volumes.
3. Capture each elution rinse and analyze by HPLC.

Reaction efficiency and elution efficiency was compared to the standard method. For gas capture, the standard elution was 1.26 mL of 40% MeOH which yielded a sample volume of 0.8 mL. The objective of the heterogeneous method was reaction efficiency greater than or equal to the corresponding standard method and efficient elution in a small single rinse with 90% or more recovery in a single small volume.

### Example 3: Heterogeneous Labeling, Acid Treated Silica

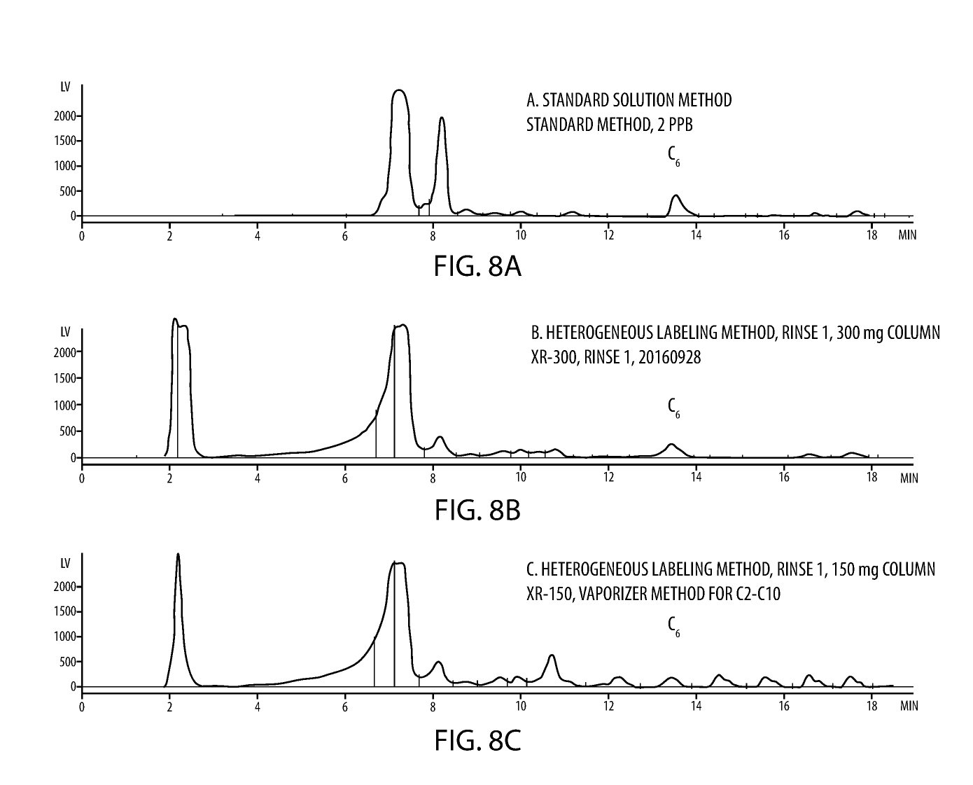

Effective capture, labeling and release can be accomplished using a heterogeneous method. The standard solution method and an example of heterogeneous labeling column method using a silica matrix are compared in FIGS. 8A, B and C. The heterogeneous reactive columns were prepared as described above. For the Standard Solution Method buffer, catalyst and labeling reagent were added to the 40% MeOH elution solution (volume≈800 μL) to yield a final concentration of 6.8 μM labeling regent, 3 mM catalyst, 75 mM citrate buffer pH4.2. The reaction was incubated a minimum of 1 hour. The sample consisted of humidified Hexanal, 10 L 2 ppb, about 0.8 nmol aldehyde. The solution molar ratio label:aldehyde was about 7:1. The corresponding HPLC profile 800 is displayed in FIG. 8A. In FIG. 8B, the HPLC profile of Rinse 1, elution volume of 1 mL from a “heterogeneous” labeling column, of 300 mg, acid treated silica, XR-300 is displayed 802. The aldehyde exposure was the same as in FIG. 8A with a reaction incubation z 3 min. FIG. 8C contains the HPLC profile of Rinse 1, elution volume of 1 mL from a “heterogeneous” labeling of sample containing a mixture of C2-C10 aldehydes 804. The labeling column was 150 mg, acid treated silica, XR150. The hexanal levels in all three profiles are similar 806. The data indicates similar reaction efficiencies for the two processes. The heterogeneous method was faster and did not require a catalyst.

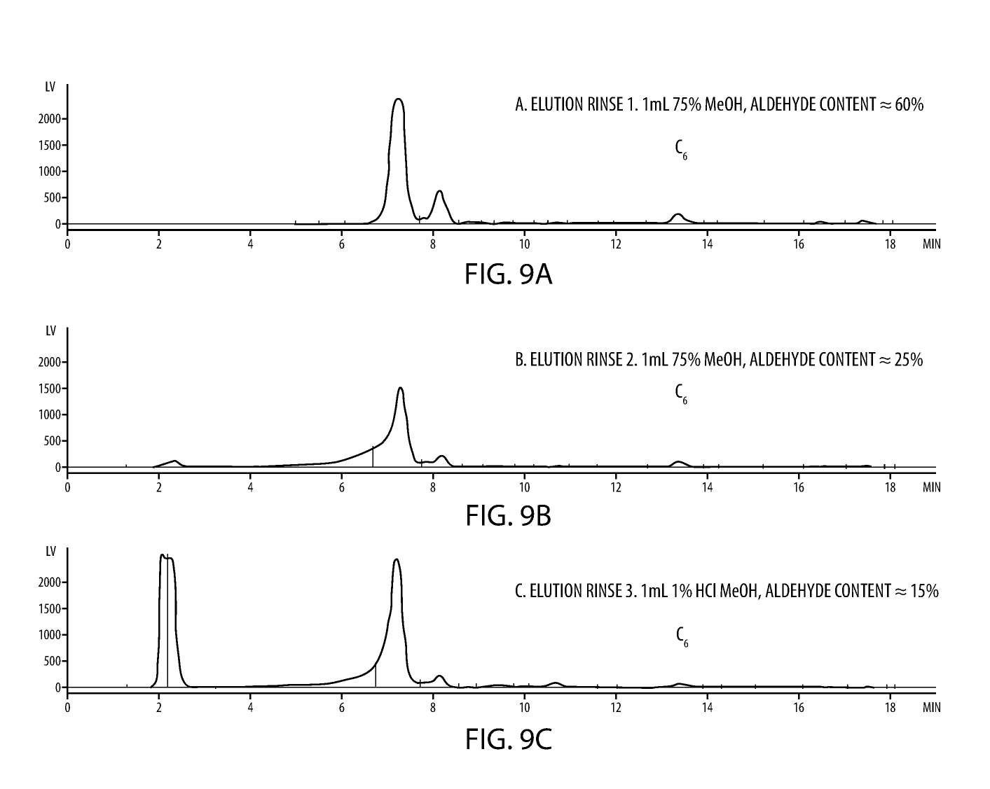

An example of an inefficient removal or elution process is displayed in FIGS. 9A, B and C. In this elution process, the labeled aldehyde bled off into three different elution rinses. Rinse 1, of 1 ml 75% methanol having an aldehyde content of 60% 900, rinse 2, 1 ml 75% methanol, aldehyde content of 25% 902, and rinse 3, 1 ml 1% HCl methanol, aldehyde content of 15% 904. The dilution of the sample limited the utility and sensitivity of the methodology.

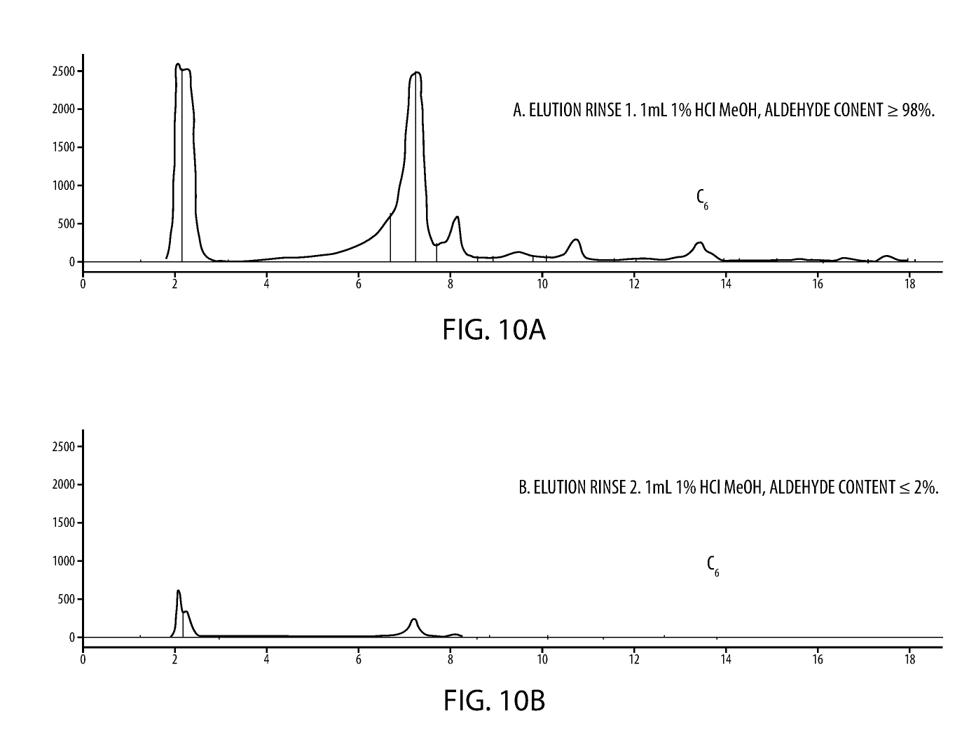

In FIGS. 10A and B, the elution was efficient using 1% HCl/methanol. The labeled aldehyde was removed in a single rinse (elution rinse, 1 ml 1% HCl/methanol, aldehyde content greater than 98%) 1000. The second rinse under the same conditions left less than 2% aldehyde 1002. Acidification with HCl promoted the elution of the 6-ao-TAMRA labeled aldehyde. While not wishing to be held to theory, acidic pH appears to enhance the elution, though citrate and acetic acid do not appear to be as efficient as dilute HCl. Efficient elution can be obtained with lower concentration of MeOH with HCl added, e.g. 60-75% MeOH.

The methodology is adaptable to a variety of matrices. Several reverse phase matrices (C2, C8, C18 and phenyl) were examined. While contemplated herein, under the conditions tested, these matrices do not appear to be as efficient as silica. Silica provides both capture efficiency and potential activation properties that the reverse phase matrices do not. The reduction in efficiency may be due to combination of reactivity differences and optimized elution. A general trend toward reduced elution was observed for the longer chain more hydrophobic media which presumably more tightly bound the labeling agent and labeled product than the less hydrophobic media.

### Example 4. Dispense Method for Heterogeneous Labeling “on the Fly” Preparation of Heterogeneous Matrices at the Time of Use

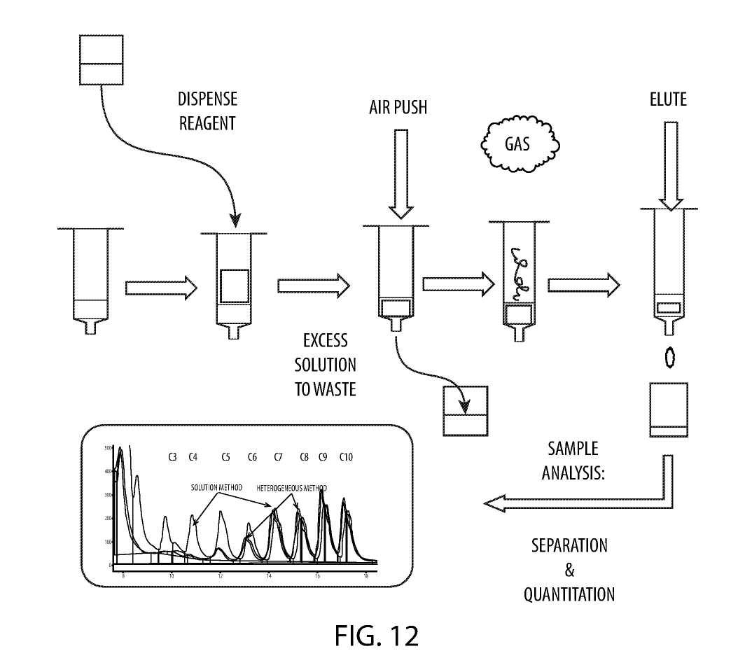

In the examples above, the reactive heterogeneous matrix is prepared before use by addition of the labeling agent and drying. In this format, multiple labeling columns can be prepared prior to use and the need for dispensing of the liquid labeling reagent at the time of use is eliminated. This requires that the labeling reagent is stable on the surface. In general, this requires balancing or modulating the reactivity of the reagent on the surface to provide for longer term stability. Formation of the heterogeneous reactive column at the time of use provides a mechanism to leverage the advantages of the heightened reactivity while reducing the risk of decomposition. It provides a means to exploit the reactivity advantages of the heterogeneous reactions and the stability afforded by the solution formulation. An “on the fly” scheme is dependent upon the ability of the heterogeneous labeling to occur without complete drying and processing of the surface. An effective capturing, labeling, and release of aldehydes using an “on the fly” scheme has been developed. The scheme 1200 is illustrated in FIG. 12. In this process, the reactive labeling reagent 1202 is dispensed onto the silica surface 1204 just prior to use (shown by arrow 1206). Excess solvent 1208 can be removed by an air push (arrow 1210) and then the sample is added 1212. Alternatively, a gas sample can be administered right after the dispensing. The leading edge of the sample flow removes excess solvent and adequately prepares the reactive heterogeneous surface. Elution and sample analysis are described previously. 1214, 1216 respectively)

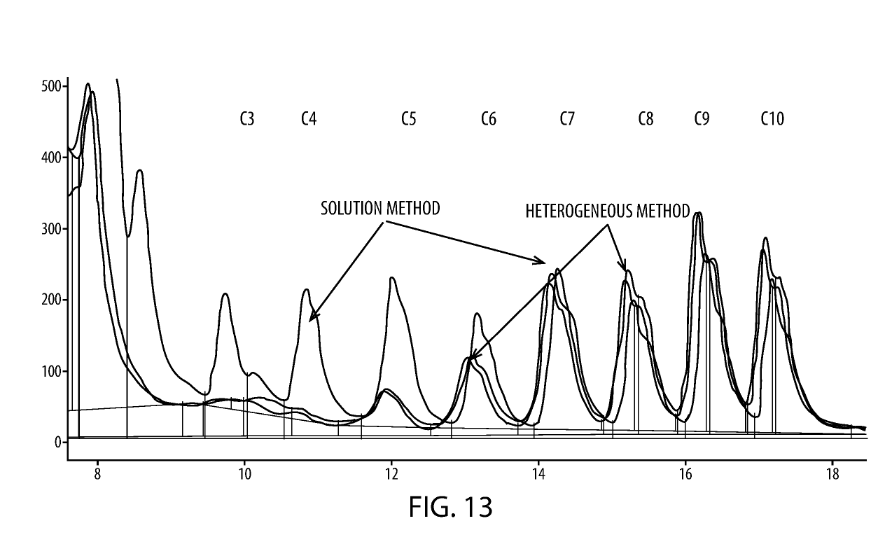

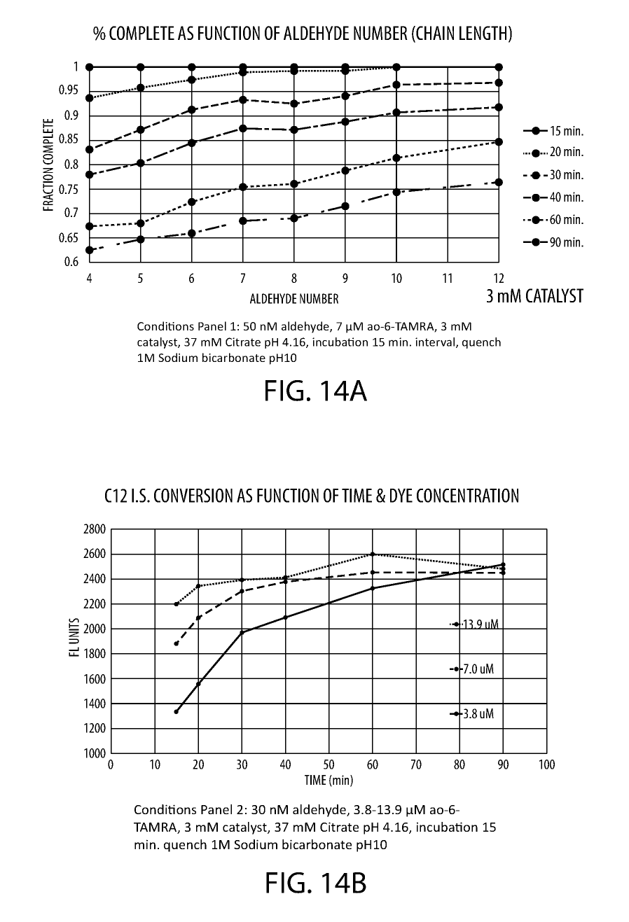

An example of labeling by this scheme versus a homogenous solution reaction is displayed in FIG. 13. The area and intensity levels for C7-C10 correspond between the two methods (solution method 1300, heterogeneous method 1302). For the heterogeneous method C2-C6 the area and intensities appear to be reduced relative to the homogenous method. The heterogeneous method is kinetically driven and reflects the difference in the kinetics as a function of chain length. The homogenous method with the excess of catalyst and at longer incubation times masks this difference. The kinetic differences can be observed when the solution is examined at short time periods and with reduced catalyst (see FIGS. 14A and B). The kinetics for the solution and heterogeneous methods are consistent and exhibit similar trends. The heterogeneous method provides a selection mechanism for reducing interference from shorter chain aldehydes.

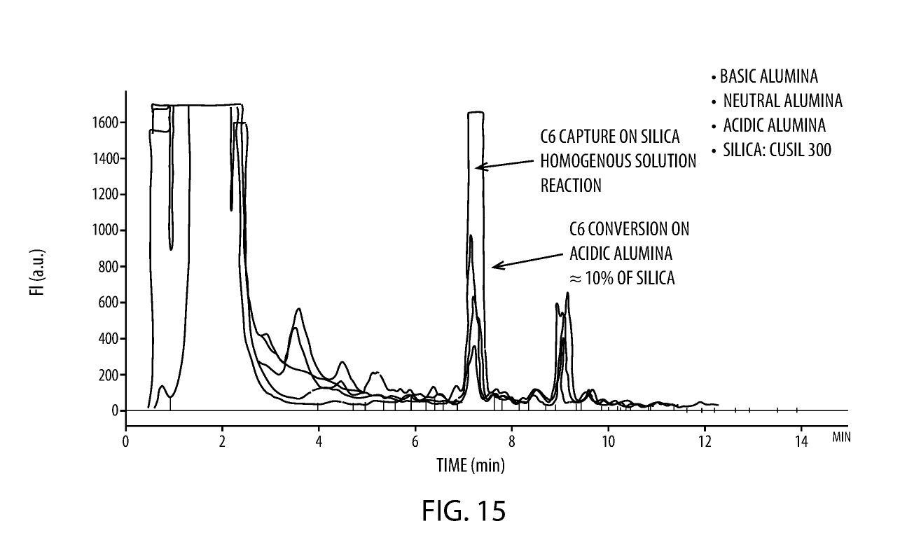

An example of using different media is contained in FIG. 15. Acid treated alumina supported heterogeneous labeling of aldehydes using the same labeling reagent as used with acid treated silica but the conversion was significantly less. The relative conversion was 10% of that observed for acid treated silica.

The dispense method utilized the stability of the reagents but still captured the increased selectivity.

### Selective Capture.

The use of a heterogeneous method provides another potential benefit. The reactive labeling reagent provided a mechanism for enhanced selectivity during the capture process by sequestering targets on the capture matrix based upon differential reactivity. This is particularly important in situations where confounder populations are in great excess. The number of total sites for capture is determined principally by the bed mass and particle size. In situations where confounders are 1000× of the target molecule, the total amount of target may be restricted due to saturation of sites by confounders. If the confounder reactivity is several orders of magnitude less than the target, then the target population may be enhanced by covalent binding of the target to the matrix. The confounder population would continue to diffuse on and off the matrix while the target is trapped. Sites would eventually be populated by the target analyte. Acetone serves as an example: the reactivity is more than 20,000× less than hexanal. The confounder population can be an excess of 1000×. Though hexanal can be easily seen in a solution mixture, once captured, the detection may be limited by the capture process. Use of a heterogeneous label/capture method can potentially nullify the presence of excess confounder population.

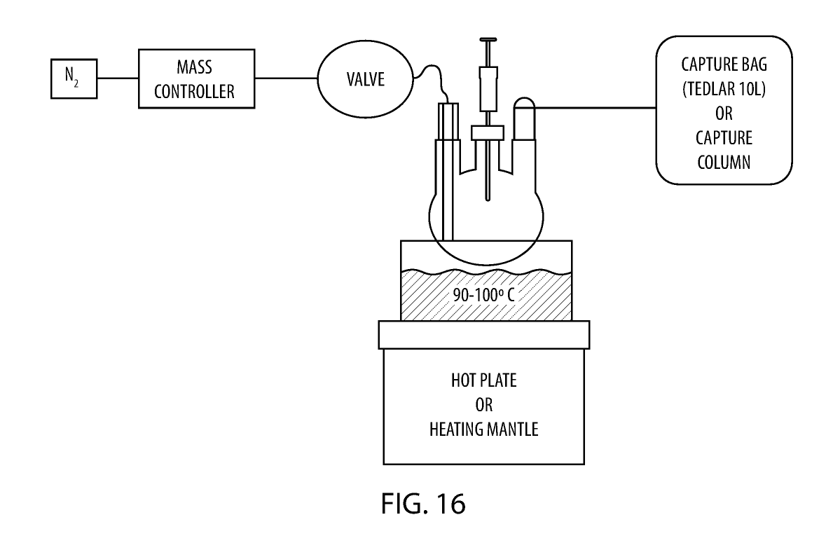

FIG. 16 depicts a vaporization apparatus 1600. Long chain aldehydes such are C7-C10 are not available commercially in the gas phase and must be generated by direct vaporization in-situ (at the time of use). In the direct vaporization method solution prepared aldehyde mixtures are volatized by heat within a three neck round bottom flask 1602. One neck 1604 equipped with automated switchable directional value 1605 provides inlet flow for carrier gas (N₂) 1606. Flow is controlled by mass flow controller 1608, typical flow 2.0 to 3.0 L/min. Aldehyde mixtures contained within a volatile solvent (methanol, acetonitrile) are injected into the apparatus via a syringe attached to the 2^{nd} neck 1610. Typically 30 μL of solution is added. Assuming 100% vaporization, 30 μL of 13.33 μL provides 400 μmol of aldehyde. The system is immersed in a 1 L beaker of water 1612 heated to (90-100° C.). A 10 L bag or capture column 1614 is attached to the third next or exit port 1616. Following addition of the aldehyde mixture and immersion into the water path, the flow is switched to the “On” position and the C2-C10 vapor is transferred to the 10 L bag or capture column.

### CONCLUSIONS

The heterogeneous capture label method is efficient for the capture and labeling on a heterogeneous support containing the dye alone, and without the need for a catalyst. The system is simple and reduces the number of solutions and additions needed. Labeling efficiency for the reverse phase materials C2, C8, C18 and phenyl may be due to reactivity or due to recovery differences.

Acid activated silica, or acid treated silica, appeared to provide the highest labeling efficiency. Signal levels similar to the standard solution method could be observed. The main difficulty is band shape broadening due to the organic content and acidity of the elution solution.

Methanol with 0.1% HCl provides an exemplary elution solution, reducing the volume of solution needed to elute the labeled material.

Labeling occurs in the absence of a catalyst and without significant incubation periods. The flow rate and resonance time does appear to modulate the efficiency. A 300 mg column delivered higher signals than a 150 mg column, possibly due to either the number of binding sites or resonance time in the column at 3 L/min. A reduced flow rate can permit resolution using a smaller column.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims.

What is claimed is:

1. A method for detecting the presence of at least one aldehyde in a sample, the method comprising the steps of:
(a) dispensing reactive labeling reagent in solution on to a capture column such that the capture column is pre-loaded with reactive labeling reagent;
(b) pushing the sample through the column to form a labeled sample, wherein the labeled sample comprises one or more labeled compounds;
(c) eluting the one or more labeled compounds from the capture column with an organic solvent solution selected from DMF, DMSO, ethanol, acetonitrile, water miscible solvent, n-methyl pyrrolidone, and methanol/water/HCl solution;
(d) dispensing the one or more labeled compounds onto a separation column;
(e) separating the one or more labeled compounds from one another by using isocratic methods or changing gradients (linear, stepwise, piecewise, or parabolic), using methanol or water miscible solvent and water and/or buffer; and
(f) detecting the separated one or more labeled compounds in the solution, wherein the separated one or more compounds is identified as being at least one aldehyde.

2. The method of claim 1, wherein step (a) further comprises drying the capture column after being pre-loaded with reactive labeling reagent.

3. The method of claim 1, further comprising (g) measuring the concentration of the at least one aldehyde.

4. The method of claim 1, wherein the time elapsed from (b) through (f) is less than about 1 hour.

5. The method of claim 1, wherein the time elapsed from (b) through (c) less than about 10 minutes.

6. The method of claim 1, wherein the at least one aldehyde is selected from the group consisting of a C1 aldehyde, a C2 aldehyde, C3 aldehyde, a C4 aldehyde, a C5 aldehyde, a C6 aldehyde, a C7 aldehyde, a C8 aldehyde, a C9 aldehyde, a C10 aldehyde, and mixtures thereof.

7. The method of claim 1, wherein the at least one aldehyde is aliphatic, a di-aldehyde, or an aromatic aldehyde, or mixtures thereof.

8. The method of claim 1, wherein the sample comprises two or more aldehydes of different carbon chain lengths, and wherein the step of detecting the labeled aldehyde resolves each aldehyde.

9. The method of claim 1, wherein the sample is a biological sample.

10. The method of claim 1, wherein the sample is an environmental sample.

11. The method of claim 1, wherein the sample is selected from the group consisting of a breath sample, a urine sample, a blood sample, a plasma sample, and a sample of the headspace in a culture.

12. The method of claim 1, wherein the sample is a breath sample.

13. The method of claim 1, wherein the capture column comprises a material selected from the group consisting of glass, silica, polyethylene, Teflon, x9908, por-4903, polypropylene, and mixtures thereof.

14. The method of claim 1, wherein the capture column comprises acid activated silica.

15. The method of claim 1, wherein the methanol/water/HCl elution solution comprises HCl in an amount of about 0.1% to about 2.0% by volume.

16. The method of claim 1, wherein the reactive labeling agent comprises a fluorophore, a linker, and a reactive group.

17. The method of claim 16, wherein the fluorophore is selected from the group consisting of tetramethyl rhodamine (TAMRA), 5(6) TAMRA, 5 TAMRA, 6 TAMRA, rhodamine X (ROX), rhodamine 6G (R6G), rhodamine 110 (R110), and a coumarin.

18. The method of claim 16, wherein the linker is selected from the group consisting of substituted alkyl-diamines (C2-C10), substituted amino-carboxylic acids (C2-C10), and substituted polyethylene glycols (N=1-10).

19. The method of claim 16, wherein the linker is selected from the group consisting of hexanoic acid, aminohexanoic acid, cadavarine, polyethylene glycol, and polyglycol.

20. The method of claim 16, wherein the reactive group is selected from the group consisting of a hydrazine moiety, a carbohydrazide moiety, a hydroxylamine moiety, a semi-carbazide moiety, an aminooxy moiety, and a hydrazide moiety.

21. The method of claim 1, wherein the reactive labeling agent is selected from the group consisting of 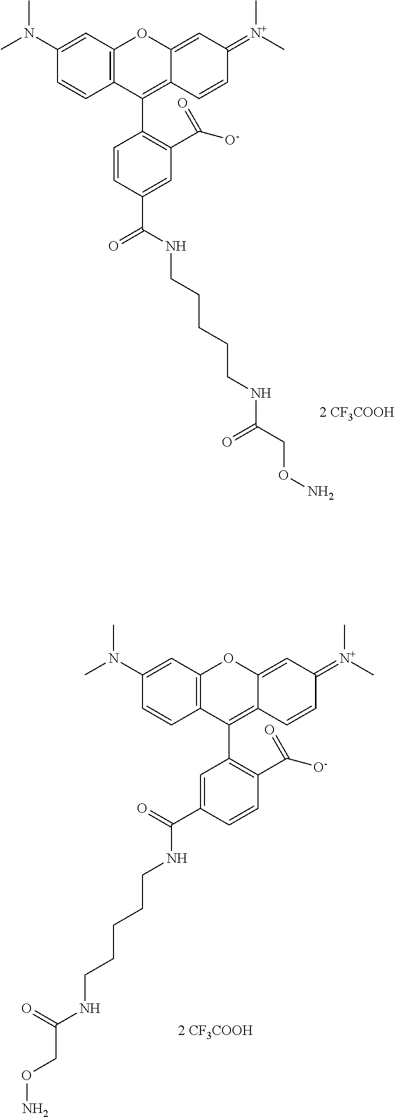 [SMILES: CN(C)c1ccc2c(-c3ccc(C(=O)NCCCCCNC(=O)CON)cc3C(=O)[O-])c3ccc(=[N+](C)C)cc-3oc2c1 ; CN(C)c1ccc2c(-c3cc(C(=O)NCCCCCNC(=O)CON)ccc3C(=O)[O-])c3ccc(=[N+](C)C)cc-3oc2c1]
and mixtures thereof.

22. The method of claim 1, wherein the step of detecting the aldehyde comprises measuring fluorescence emission produced by excitation of the fluorophore.

23. The method of claim 1, wherein the step of detecting the aldehyde comprises measuring fluorescence absorbance produced by excitation of the fluorophore.

24. The method of claim 1, wherein the step of detecting the aldehyde comprises directing light within a predetermined wavelength range to the labeled aldehyde, thereby producing a fluorescence, and detecting the fluorescence.

25. The method of claim 3, wherein the concentration of the aldehyde is determined by calculating the fluorescence excitation or emission relative to a standard curve, wherein the fluorescence signal is proportional to the concentration of the aldehyde.

26. A method for detecting the presence of at least one carbonyl containing moiety in a sample, the method comprising the steps of:
dispensing reactive labeling reagent in solution onto a capture column,
pushing the sample through the column,
eluting labeled sample with an organic solvent solution,
dispensing labeled sample onto a separation column,
separating the labeled carbonyl containing moiety using isocratic methods or changing gradients (linear, stepwise, piecewise, or parabolic), using methanol or water miscible solvent and water and/or buffer, and
detecting the labeled carbonyl containing moiety,
wherein the method of detecting is complete in less than about 1 hour.

27. The method of claim 26, wherein the carbonyl containing moiety is selected from the group consisting of aldehydes, ketones, carboxylic acids and mixtures thereof.

28. A method of detecting carbonyl containing moieties in a gas sample, the method comprising:
dispensing reactive labeling reagent in solution onto a capture column,
pushing the sample through the column,
eluting labeled carbonyl containing moieties with an organic solvent solution, dispensing labeled sample onto a separation column,
separating the labeled aldehydes using isocratic methods or changing gradients (linear, stepwise, piecewise, or parabolic), using methanol or water miscible solvent and water and/or buffer, and
exciting the labeled carbonyl containing moieties exiting the column, and
detecting the carbonyl containing moieties by measuring the fluorescence emitted from or absorbed by the labeled carbonyl containing moieties,
wherein the step of detecting resolves the carbonyl containing moieties based on the carbon chain length of the individual carbonyl containing moieties, and
wherein the time elapsed from pushing the sample through the column to detecting the carbonyl containing moieties is less than about 1 hour.

29. A system for detecting the presence of at least one carbonyl containing moiety in a sample, the system comprising:
a sample capture container,
a device comprising a capture column, wherein a labeling reagent is deposited on the capture column, a separation column, elution solutions, a pump, a light for inducing fluorescence, a detection chamber, and a detector for measuring fluorescence emission, excitation, or absorbance of at least one labeled carbonyl containing moiety.

30. The system of claim 29, wherein the device receives a sample containing at least one carbonyl containing moiety from the sample capture container, deposits the sample onto the capture column embedded with the labeling reagent, performs an elution process on the column to elute the labeled carbonyl containing moiety, dispenses the labeled carbonyl containing moiety onto a separation column, separates the labeled carbonyl containing moiety exiting the column, measures the labeled carbonyl containing moiety, and presents data identifying the at least once carbonyl containing moiety.

31. The system of claim 29, further comprising one or more standards for measuring the concentration of the at least one carbonyl containing moiety.

32. A method for detecting the presence of at least one carbonyl containing moiety in a sample, the method comprising the steps of:
(a) dispensing buffer in solution on to a solid substrate and drying the substrate;
(b) dispensing catalyst in solution on to a solid substrate and drying the substrate;
(c) dispensing reactive labeling reagent in solution on to a solid substrate and drying the substrate;
(d) layering a solid capture substrate, the substrate from (a), the substrate from (b), and the substrate from (c) in series;
(e) pushing the sample through the column, where the at least one carbonyl containing moiety is captured by the solid capture substrate;
(f) eluting the carbonyl containing moiety with an organic solvent solution selected from DMF, DMSO, ethanol, acetonitrile, water miscible solvent, n-methyl pyrrolidone, and methanol/water/HCl solution, whereby the carbonyl containing moiety, the buffer, the catalyst, and the reactive labeling reagent form an elution/reaction solution;
(g) incubating the elution/reaction solution to obtain at least one labeled carbonyl containing moiety;
(h) dispensing the solution containing at least one labeled carbonyl containing moiety onto a separation column;
(i) separating the labeled carbonyl containing moiety using isocratic methods or changing gradients (linear, stepwise, piecewise, or parabolic), using methanol or water miscible solvent and water and/or buffer; and
(j) detecting at least one labeled carbonyl containing moiety in the solution.

33. A method for detecting the presence of at least one carbonyl containing moiety in a sample, the method comprising the steps of:
(a) dispensing reactive labeling reagent in solution on to a capture column and drying the column;
(b) pushing the sample through the column;
(c) eluting labeled sample with an organic solvent solution selected from DMF, DMSO, ethanol, acetonitrile, water miscible solvent, n-methyl pyrrolidone, and methanol/water/HCl solution;
(d) dispensing labeled sample onto a separation column;
(e) separating the labeled carbonyl containing moiety using isocratic methods or changing gradients (linear, stepwise, piecewise, or parabolic), using methanol or water miscible solvent and water and/or buffer; and
(f) detecting at least one labeled carbonyl containing moiety in the solution.

34. A method for detecting the presence of at least one carbonyl containing moiety in a sample, the method comprising the steps of:
(a) dispensing buffer in solution on to a solid substrate and drying the substrate;
(b) dispensing catalyst in solution on to a solid substrate and drying the substrate;
(c) dispensing reactive labeling reagent in solution on to a solid substrate and drying the substrate;
wherein one or more of the buffer, the catalyst, and the reactive labeling agent are dispensed onto the same solid substrate, and layering a solid capture substrate in series with the substrates of (a), (b), and (c);
(d) pushing the sample through the column, where the at least one carbonyl containing moiety is captured by the solid capture substrate;
(e) eluting the carbonyl containing moiety with an organic solvent solution selected from DMF, DMSO, ethanol, acetonitrile, water miscible solvent, n-methyl pyrrolidone, and methanol/water/HCl solution, whereby the carbonyl containing moiety, the buffer, the catalyst, and the reactive labeling reagent form an elution/reaction solution;
(f) incubating the elution/reaction solution to obtain at least one labeled carbonyl containing moiety;
(g) dispensing the solution containing at least one labeled carbonyl containing moiety onto a separation column;
(h) separating the labeled carbonyl containing moiety using isocratic methods or changing gradients (linear, stepwise, piecewise, or parabolic), using methanol or water miscible solvent and water and/or buffer; and
(i) detecting at least one labeled carbonyl containing moiety in the solution.

35. A column comprising a solid substrate and a reactive labeling reagent embedded onto the substrate.
